(19) United States
(12) Patent Application Publication
(10) Pub. No.: US 2017/0138379 A1
(43) Pub. Date: May 18, 2017

(54) CLIPS

(71) Applicant: DAIWA KASEI KOGYO KABUSHIKI KAISHA, Okazaki-shi (JP)

(72) Inventors: Toshio IWAHARA, Okazaki-shi (JP); Makoto KATO, Toyota-shi (JP); Katsuya HIRAKAWA, Toyokawa-shi (JP)

(21) Appl. No.: 15/349,795

(22) Filed: Nov. 11, 2016

(30) Foreign Application Priority Data
Nov. 16, 2015 (JP) 2015-224008

(51) Int. Cl. F16B 2/22; B60R 16/02; B65D 63/10

(52) U.S. Cl. CPC F16B 2/22; B65D 63/1027; B60R 16/0215; B65D 2563/108

(57) ABSTRACT

A clip may include an engagement leg and may be configured to be attached to an object member in a condition in which the engagement leg is fitted into an elliptical attaching hole formed in the object member. The engagement leg may include a pillar configured to be inserted into the attaching hole from its distal end to its proximal end, and engagement strips configured to engage a periphery of the attaching hole when the engagement leg is inserted into the attaching hole. The pillar may include upright opposite surfaces respectively formed in a portion adjacent to the proximal end of the pillar, inclined opposite surfaces respectively formed in a portion adjacent to the distal end of the pillar, and relief surfaces respectively formed in areas partially overlapping at least the inclined opposite surfaces and inclined about an axis of the pillar.

### BACKGROUND

The present disclosure relates to fasteners or clips. More particularly, the present disclosure relates to fasteners or clips that are configured to be connected to an object member (e.g., a body panel of a vehicle) by inserting engagement legs of the clips into elongated or elliptical attaching holes formed in the object member.

A known clip is taught by, for example, Japanese Laid-Open Patent Publication No. 2006-242269 (JP2006-242269A). The clip is combined with a tying belt (a cable tying member) so as to form a cable tie that is used to attach a wiring harness (a clamped article) used for vehicle wiring to a body panel (an object member). The clip includes a base and an engagement leg. The engagement leg is integrated with the base and is configured to be inserted into an attaching hole formed in the body panel. The engagement leg is composed of a pillar that is vertically projected from the base, and a pair of engagement strips that are respectively laterally obliquely projected from a distal end of the pillar. The tying belt is connected to the base and is configured to be fastened around the wiring harness.

In order to attach the wiring harness to the body panel, first, the tying belt of the clip is fastened around the wiring harness, so that the clip may be connected to the wiring harness. Thereafter, the engagement leg is simply pressed into the attaching hole of the body panel, so as to be inserted thereinto while the engagement strips are respectively flexed inward with respect to the pillar. When the engagement leg is sufficiently inserted into or fitted into the attaching hole, the engagement strips elastically engage an inner periphery of the attaching hole, so that the engagement leg can be retained therein. Thus, the clip is attached to the body panel. As a result, the wiring harness can be attached to the body panel by the clip.

Further, in the known clip, the engagement strips of the engagement leg respectively have depressed or removed portions that are respectively formed in outer peripheries thereof. Therefore, when the engagement leg is pressed into the attaching hole of the body panel while an axis of the engagement leg is inclined with respect to an axis of the attaching hole, the depressed portions of the engagement strips may contact the inner periphery of the attaching hole. As a result, the engagement strips may respectively be easily inwardly flexed with respect to the pillar. Thus, the engagement leg can be inserted into the attaching hole even when the engagement leg is axially obliquely pressed into the attaching hole.

Conversely, the engagement leg may sometimes be pressed into the attaching hole of the body panel while the engagement leg is rotationally displaced about the axis of the attaching hole (i.e., while the engagement leg is rotationally misaligned with the attaching hole). In such a case, the engagement leg may not be easily and adequately inserted into the attaching hole depending on the shape of the attaching hole. For example, when the attaching hole has an elliptical (elongated) shape substantially corresponding to a cross-sectional shape of the engagement leg, the pillar of the engagement leg may interfere with the inner periphery of the attaching hole due to rotational displacement of the engagement leg. This may increase an insertion resistance of the engagement leg during an insertion operation of the engagement leg into the attaching hole. As a result, the engagement leg may be prevented from being easily and adequately inserted into the attaching hole.

Generally, the wiring harness is attached to the body panel using a plurality of clips because the wiring harness is an elongated member. Therefore, when the engagement leg of the clip (each of the plurality of clips) is pressed into the attaching hole in order to attach the wiring harness to the body panel, the clip may be subjected to a rotative force caused by deviation and torsion of the elongated wiring harness. As a result, the engagement leg may be rotationally displaced about the axis of the attaching hole. That is, the engagement leg may be rotationally misaligned with the attaching hole.

Therefore, there is a need in the art for an improved clip.

### SUMMARY

In one aspect of the present disclosure, a clip may have an engagement leg and may be configured to be attached to an object member in a condition in which the engagement leg is fitted into an elliptical attaching hole formed in the object member. The engagement leg may include a pillar configured to be inserted into the attaching hole from its distal end to its proximal end, and engagement strips respectively positioned in both lateral sides of the pillar so as to be elastically deformed toward and away from the pillar and configured to engage a periphery of the attaching hole when the engagement leg is inserted into the attaching hole. The pillar may include upright opposite surfaces respectively formed in a portion adjacent to the proximal end of the pillar and configured such that a distance therebetween in a direction perpendicular to the engagement strips may be constant over the entire length thereof, inclined opposite surfaces respectively formed in a portion adjacent to the distal end of the pillar and inclined such that a distance therebetween in the direction perpendicular to the engagement strips may be gradually reduced from end peripheries of the upright opposite surfaces toward the distal end of the pillar, and relief surfaces respectively formed in the pillar in areas partially overlapping at least the inclined opposite surfaces and inclined about an axis of the pillar.

Optionally, the engagement strips may respectively have shoulder portions that are most projected outward, and relief surfaces that are formed by removing outer corner portions of the shoulder portions.

According to this aspect, when the engagement leg is inserted into the elliptical attaching hole in a condition in which the engagement leg is inclined with respect to an axis of the attaching hole and/or in a condition in which the engagement leg is rotationally misaligned with the attaching hole, an axial inclination and/or a rotational misalignment of the engagement leg with respect to the attaching hole can be simultaneously corrected before the engagement leg reaches a fitted condition because the inclined opposite surfaces and the relief surfaces of the pillar pass through the attaching hole. As a result, an insertion resistance of the engagement leg caused by the interference of the pillar with a circumferential surface of the attaching hole may be reduced. In addition, the fitted condition of the engagement leg within the attaching hole may be constantly optimized.

Further, in the fitted condition of the engagement leg, the upright opposite surfaces may contact the circumferential surface of the attaching hole in the form of surface contact. Therefore, the engagement leg in the fitted condition may be reliably positioned in the attaching hole without being rattled.

Further, the engagement strips of the engagement leg may have the relief surfaces that are formed in the shoulder portions thereof. Therefore, even when the engagement leg of the clip is rotationally displaced about the axis of the attaching hole of the object member, the relief surfaces of the engagement strips may reduce an insertion resistance of the engagement leg caused by the interference of the engagement strips with the circumferential surface of the attaching hole. This may contribute to an easy insertion operation of the engagement leg.

Additional objects, features and advantages of the present disclosure will be readily understood after reading the following detailed description together with the accompanying drawings and the claims.

### BRIEF DESCRIPTION OF THE DRAWINGS

FIG. 1 is a perspective view of a cable tie to which a clip according to a first representative embodiment is applied;

FIG. 2 is a perspective view of the cable tie, which view is viewed from the back side of FIG. 1;

FIG. 3 is a side view of the cable tie, which view shows a condition in which the cable tie is in use;

FIG. 4 is a perspective view of a cable attachment to which the clip according to the first representative embodiment is applied;

FIG. 5 is a perspective view of a different type of cable attachment that is modified from the cable attachment of FIG. 4;

FIG. 6 is a perspective view of the clip according to the first representative embodiment;

FIG. 7 is an elevational view of the clip shown in FIG. 6;

FIG. 8 is a side view of the clip shown in FIG. 6;

FIG. 9 is a plan view of the clip shown in FIG. 6;

FIG. 10 is a rear elevational view of the clip shown in FIG. 6;

FIG. 11 is a cross-sectional view taken along line XI-XI in FIG. 7;

FIG. 12 is a perspective view of the clip, which shows a pre-insertion condition immediately before an engagement leg of the clip is inserted into an attaching hole formed in a body panel;

FIG. 13 is a plan view of the clip shown in FIG. 12;

FIG. 14 is a perspective view of the clip, which shows an initial insertion condition in which the engagement leg of the clip is started to be inserted into the attaching hole;

FIG. 15 is a plan view of the clip shown in FIG. 14;

FIG. 16 is a perspective view of the clip, which shows an intermediate insertion condition in which the engagement leg of the clip is inserted into the attaching hole to some extent;

FIG. 17 is a plan view of the clip shown in FIG. 16;

FIG. 18 is a perspective view of the clip, which shows a final insertion condition in which the engagement leg of the clip is further inserted into the attaching hole;

FIG. 19 is a plan view of the clip shown in FIG. 18;

FIG. 20 is a perspective view of the clip, which shows an insertion completion condition in which the engagement leg of the clip is completely inserted or fitted into the attaching hole;

FIG. 21 is a cross-sectional view taken along line XXI-XXI in FIG. 20;

FIG. 22 is a cross-sectional view taken along line XXII-XXII in FIG. 20;

FIG. 23 is a perspective view of a clip according to a second representative embodiment;

FIG. 24 is an elevational view of the clip shown in FIG. 23;

FIG. 25 is a side view of the clip shown in FIG. 23;

FIG. 26 is a plan view of the clip shown in FIG. 23;

FIG. 27 is a rear elevational view of the clip shown in FIG. 23;

FIG. 28 is a cross-sectional view taken along line XXVIII-XXVIII in FIG. 24;

FIG. 29 is a cross-sectional view taken along line XXIX-XXIX in FIG. 24;

FIG. 30 is a perspective view of the clip, which shows a pre-insertion condition immediately before an engagement leg of the clip is inserted into an attaching hole formed in a body panel;

FIG. 31 is a plan view of the clip shown in FIG. 30;

FIG. 32 is a perspective view of the clip, which shows an initial insertion condition in which the engagement leg of the clip is started to be inserted into the attaching hole;

FIG. 33 is a plan view of the clip shown in FIG. 32;

FIG. 34 is a partially enlarged view of FIG. 33;

FIG. 35 is a perspective view of the clip, which shows an intermediate insertion condition in which the engagement leg of the clip is inserted into the attaching hole to some extent;

FIG. 36 is a plan view of the clip shown in FIG. 35;

FIG. 37 is a perspective view of the clip, which shows a final insertion condition in which the engagement leg of the clip is further inserted into the attaching hole;

FIG. 38 is a plan view of the clip shown in FIG. 37;

FIG. 39 is a perspective view of the clip, which shows an insertion completion condition in which the engagement leg of the clip is completely inserted or fitted into the attaching hole;

FIG. 40 is a cross-sectional view taken along line XL-XL in FIG. 39;

FIG. 41 is a perspective view of a component attachment to which a clip according to a third representative embodiment is applied;

FIG. 42 is a perspective view of the clip according to the third representative embodiment;

FIG. 43 is an elevational view of the clip shown in FIG. 42;

FIG. 44 is a side view of the clip shown in FIG. 42;

FIG. 45 is a plan view of the clip shown in FIG. 42;

FIG. 46 is a perspective view of a multiply connectable cable attachment to which a clip according to a fourth representative embodiment is applied;

FIG. 47 is a perspective view of the clip according to the fourth representative embodiment;

FIG. 48 is an elevational view of the clip shown in FIG. 47;

FIG. 49 is a side view of the clip shown in FIG. 47;

FIG. 50 is a plan view of the clip shown in FIG. 47;

FIG. 51 is a perspective view of a cable attachment to which a clip according to a fifth representative embodiment is applied;

FIG. 52 is a perspective view of a different type of cable attachment that is modified from the cable attachment of FIG. 51;

FIG. 53 is a perspective view of a corrugated tube clamp to which the clip according to the fifth representative embodiment is applied;

FIG. 54 is a perspective view of the clip according to the fifth representative embodiment;

FIG. 55 is an elevational view of the clip shown in FIG. 54;

FIG. 56 is a side view of the clip shown in FIG. 54; and

FIG. 57 is a plan view of the clip shown in FIG. 54.

### DETAILED DESCRIPTION

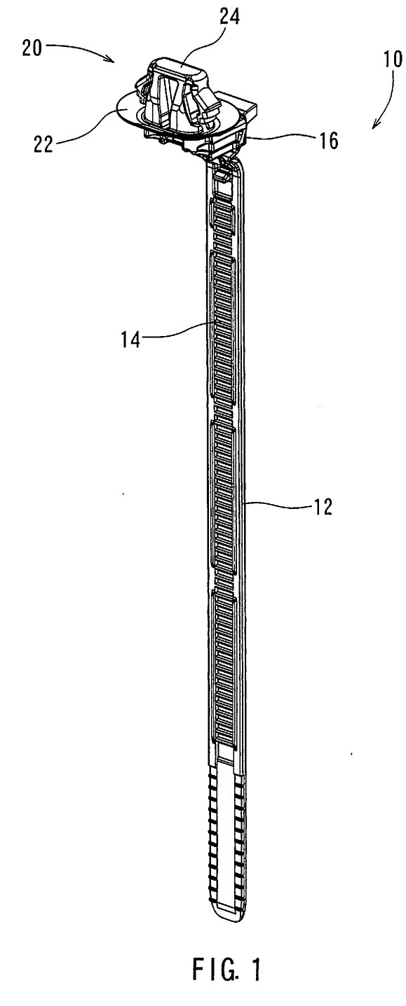

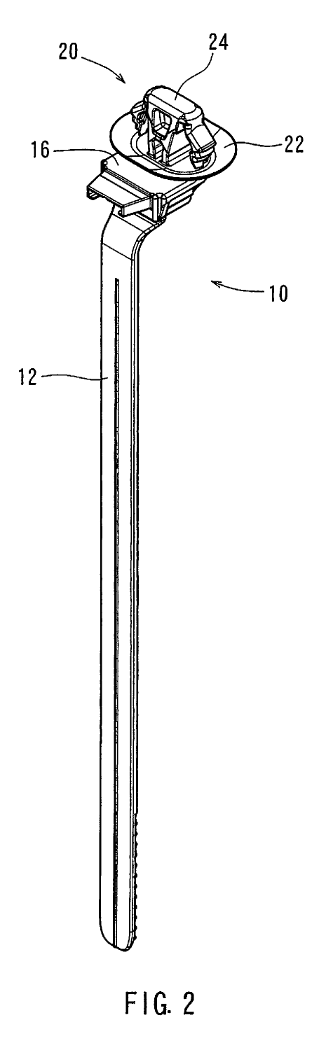

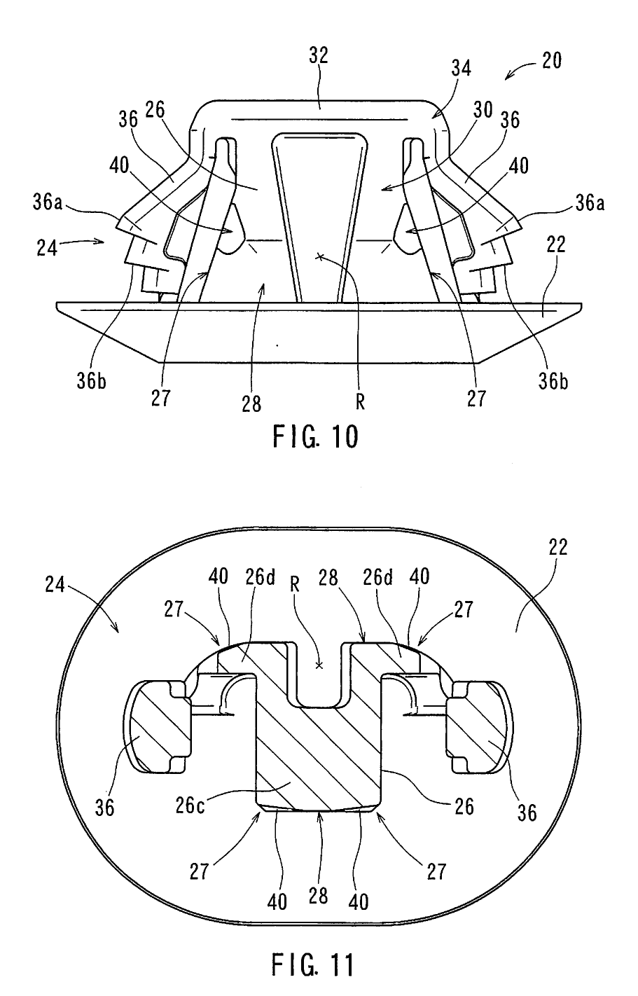

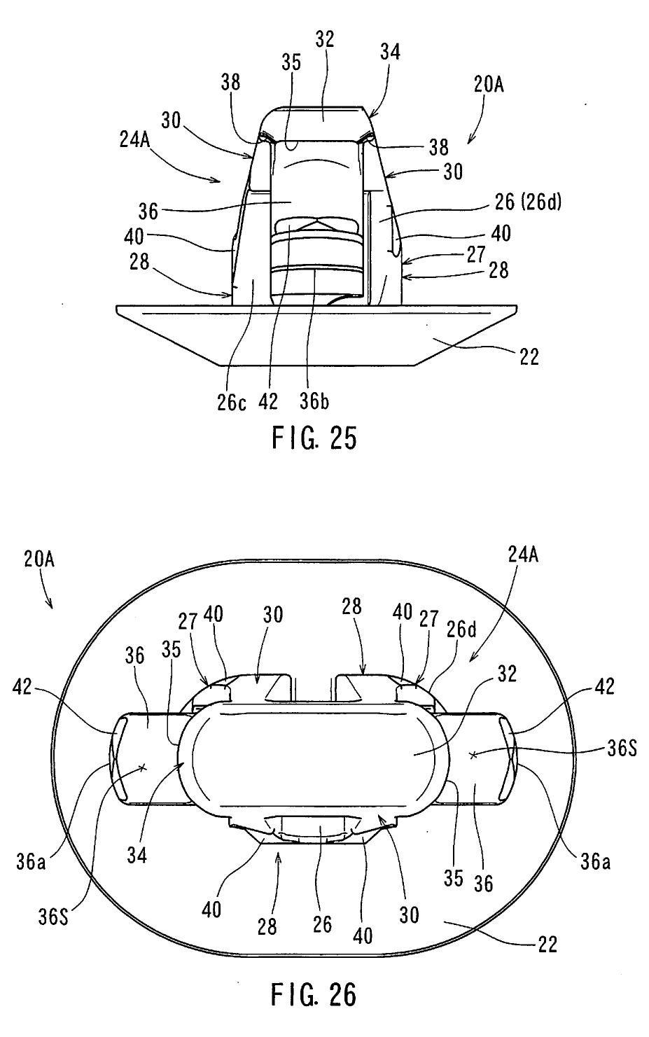

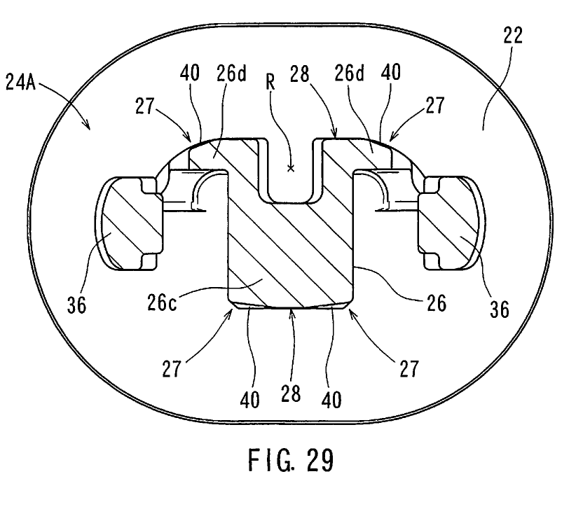

Detailed representative embodiments are shown in FIGS. 1 to 57.

### First Embodiment

In the following, a first embodiment will be described in detail with reference to FIGS. 1 to 22.

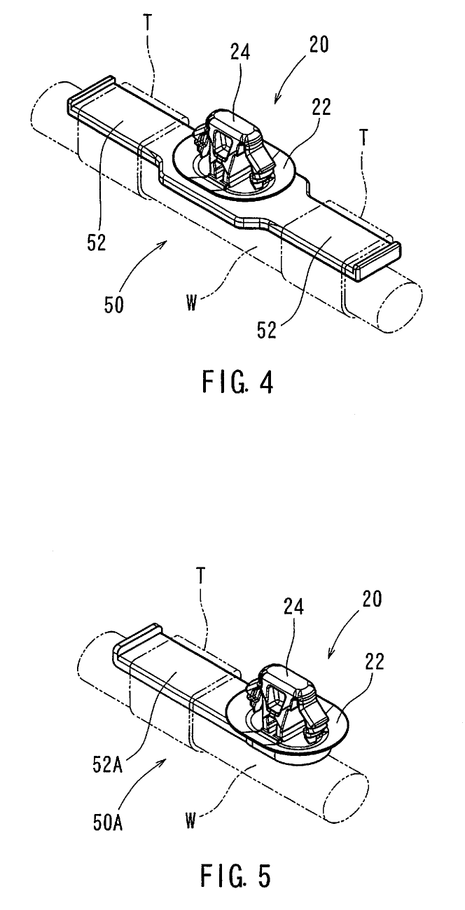

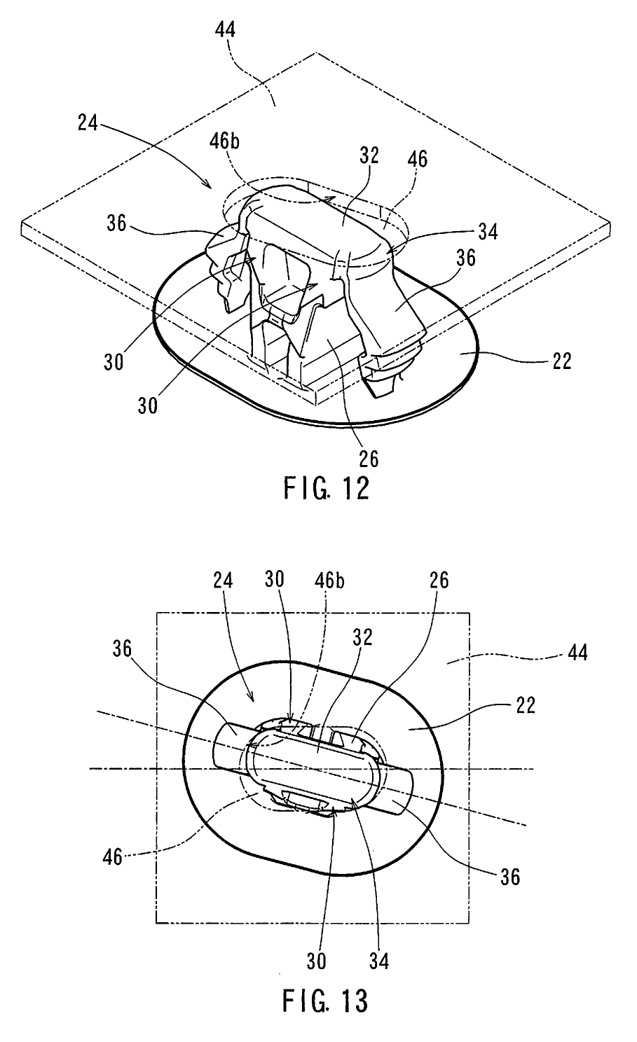

As shown in FIGS. 1 to 3, a clip 20 according to the first embodiment may be applied to a cable tie 10 that is used to attach a wiring harness W (a clamped article) used for vehicle wiring to a body panel 44 (an object member) (FIGS. 12 to 22). Further, as shown in FIGS. 4 and 5, the clip 20 may be applied to a cable attachment 50 and 50A that is used to attach the wiring harness W to the body panel 44. Each of the cable tie 10 and the cable attachment 50 and 50A may preferably be integrally formed as a unit by injection molding of a resinous material, e.g., polyethylene. As will be recognized, the clip 20 may be applied to a component attachment (not shown) and a corrugated tube clamp (not shown) other than the cable tie 10 and the cable attachment 50 and 50A.

As shown in FIGS. 1 to 3, the cable tie 10 may include a desired length of flexible belt 12 (a holding member) and a buckle 16 to which the clip 20 is integrally connected. The belt 12 may have a proximal end that is integrally connected to the buckle 16. Further, the belt 12 may have a plurality of engagement teeth or rack teeth 14 that are formed in one (inner) surface thereof. The rack teeth 14 may preferably be arranged at a constant pitch distance in a longitudinal direction of the belt 12.

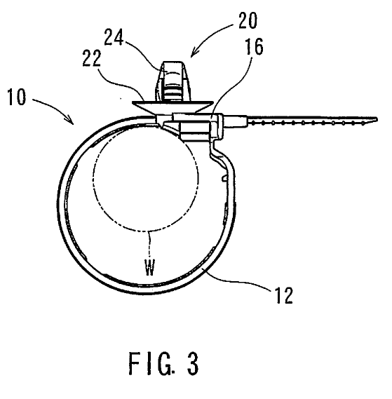

In order to attach the clip 20 to the wiring harness W, as shown in FIG. 3, the belt 12 may be looped and wrapped around an outer circumferential surface of the wiring harness W. Thereafter, the belt 12 may be inserted into a through hole (not shown) of the buckle 16 and may then be tightened by pulling a distal end thereof. At this time, an engagement projection (not shown) formed in the through hole of the buckle 16 can engage any of the rack teeth 14 formed in the belt 12, so that the belt 12 can be held in loop shape. As a result, the wiring harness W may be clamped by the cable tie 10. Thus, the clip 20 may be attached to the wiring harness W.

As shown in FIG. 4, the cable attachment 50 may include an elongated plate-shaped attachment base 52 (a holding member) to which the clip 20 is integrally connected. The attachment base 52 may be shaped so as to oppositely extend from either side of the clip 20. Conversely, as shown in FIG. 5, the cable attachment 50A may include an elongated plate-shaped attachment base 52A (a holding member) to which the clip 20 is connected. Unlike the attachment base 52, the attachment base 52A may be shaped so as to extend from one side of the clip 20.

In order to attach the clip 20 to the wiring harness W, as shown in FIGS. 4 and 5, the attachment base 52 or 52A may be longitudinally positioned along the outer circumferential surface of the wiring harness W. Thereafter, the attachment base 52 or 52A may be secured to the wiring harness W using a tape T. As a result, the cable attachment 50 or 50A may be integrated with the wiring harness W. Thus, the clip 20 may be attached to the wiring harness W.

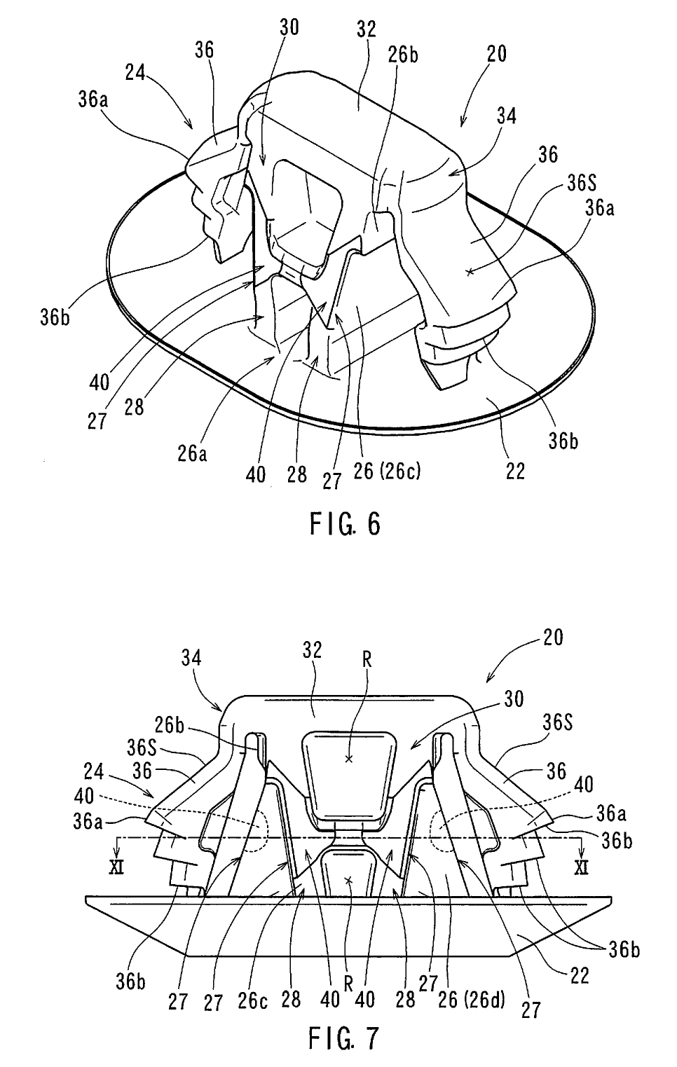

Next, the clip 20 will be described in detail with reference to FIGS. 6 to 22. Further, in FIGS. 6 to 22, the belt 12 and the buckle 16 of the cable tie 10 or the attachment base 52 and 52A of the cable attachment 50 and 50A may be omitted. The clip 20 may include a dish-shaped stabilizer 22 and an engagement leg 24 positioned on a central portion of the stabilizer 22. The engagement leg 24 may be composed of a pillar 26 and a pair of engagement strips 36 and may be configured to be inserted into an attaching hole 46 formed in the body panel 44. The pillar 26 may have a proximal end 26a that is connected to the stabilizer 22 and a distal end 26b that is formed into a head or guide portion 32.

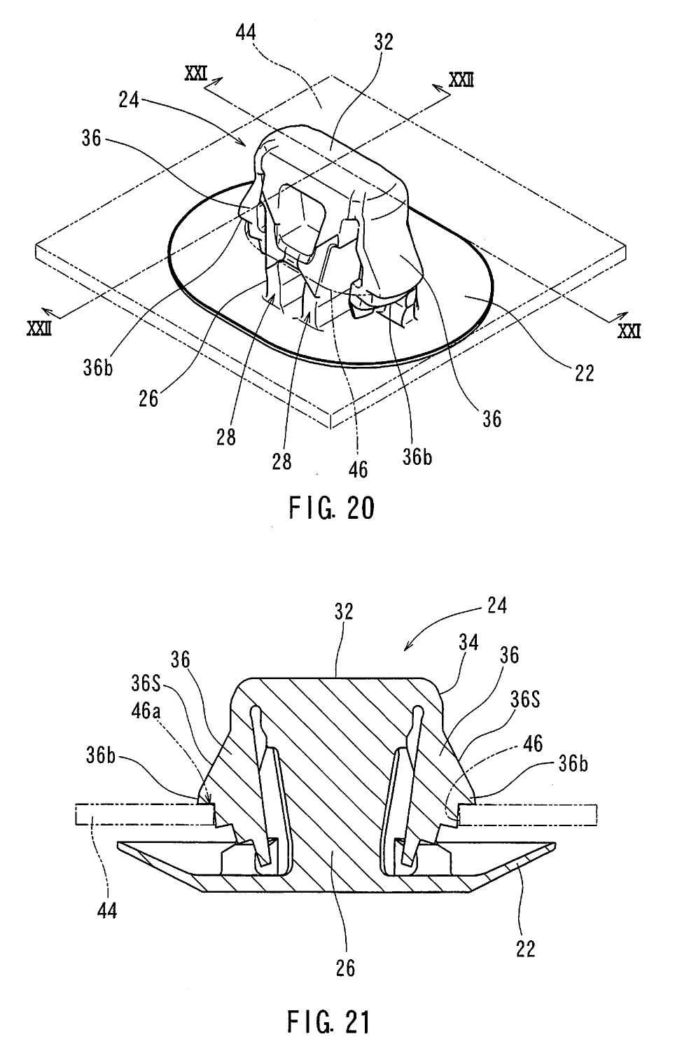

As shown in FIG. 20, upon insertion of the engagement leg 24 into the attaching hole 46 formed in the body panel 44, the clip 20 can be attached to the body panel 44. Thus, the wiring harness W can be attached to the body panel 44 by the clip 20. As will be recognized, when the engagement leg 24 is inserted into the attaching hole 46 of the body panel 44, the guide portion 32 formed in the distal end 26b of the pillar 26 may function as a leading end. Further, the attaching hole 46 may have an elliptical or oval shape having straight long sides and semicircular short sides. Conversely, the engagement leg 24 may be configured to substantially correspond to the attaching hole 46. Therefore, the engagement leg 24 inserted into the attaching hole 46 may be prevented from rotating within the attaching hole 46. As a result, the clip 20 may be prevented from rotating with respect to the body panel 44.

The pillar 26 of the engagement leg 24 may be a columnar-shaped member having front and rear sides (a first pair of opposite sides) and right and left or lateral sides (a second pair of opposite sides) and having lightening recesses R formed in the front and rear sides thereof. In particular, as best shown in FIG. 11, the pillar 26 may be composed of a rectangular columnar main portion 26c and a pair of wing portions 26d. The wing portions 26d may be formed in lateral sides of the main portion 26c. In particular, the wing portions 26d may be laterally projected from lateral sides of the main portion 26c (which sides may be referred to as the lateral sides of the pillar 26) along a rear side of the main portion 26c (which side may be referred to as the rear side of the pillar 26). Thus, the pillar 26 may have four (front and rear) outer corner portions 27 which correspond to two front corner portions of the main portion 26c and two rear corner portions of the wing portions 26d.

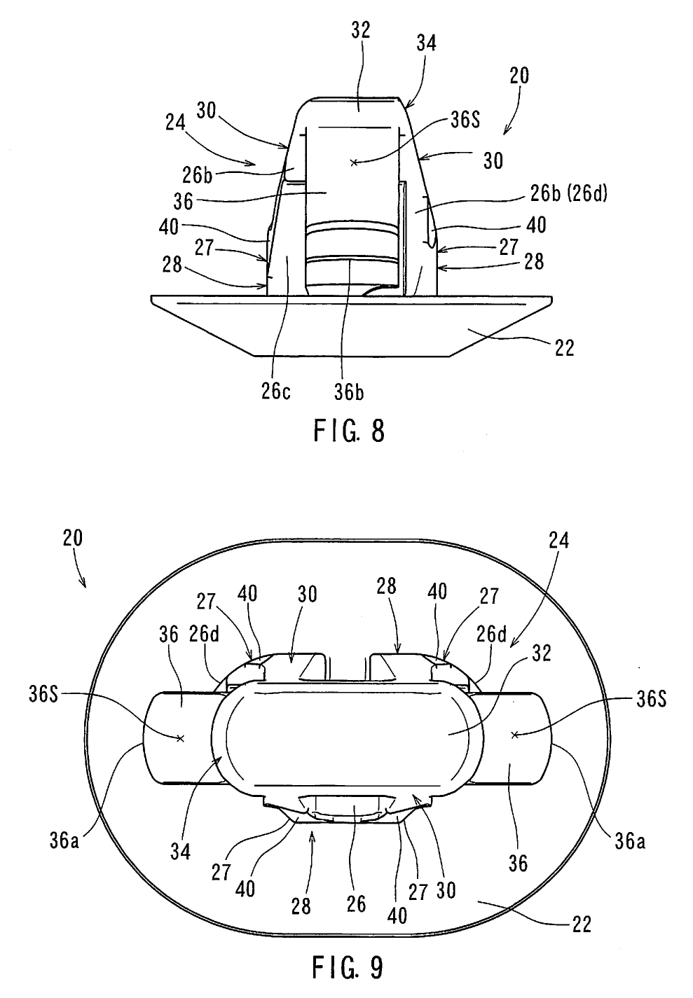

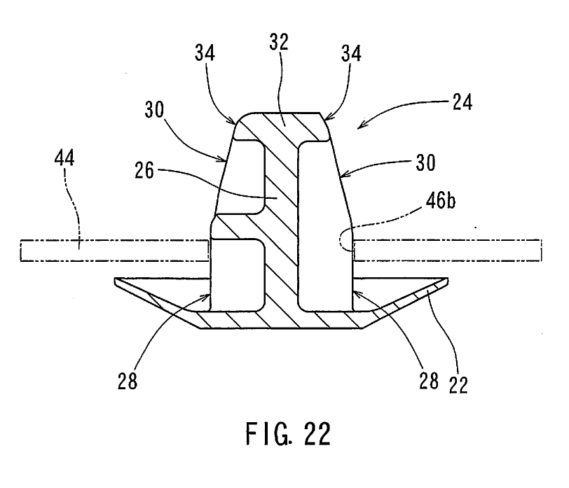

As shown in FIG. 8, the pillar 26 may have front and rear vertical or upright (first) opposite surfaces 28 and front and rear inclined (second) opposite surfaces 30 continuous with the upright opposite surfaces 28. The front and rear upright opposite surfaces 28 may respectively be formed in the front and rear sides (i.e., sides perpendicular to the engagement strips 36) of the main portion 26c so as to extend along a lower or proximal portion of the pillar 26 (i.e., along a certain portion adjacent to the proximal end 26a of the pillar 26). The front and rear inclined opposite surfaces 30 may respectively be formed in the front and rear sides of the main portion 26c so as to extend along an upper or distal portion of the pillar 26 (i.e., along a certain portion adjacent to the distal end 26b of the pillar 26). Further, the front and rear inclined opposite surfaces 30 may respectively be oppositely inclined inward toward the distal end 26b. In particular, the upright opposite surfaces 28 may extend from the proximal end 26a of the pillar 26 to a substantially central portion of the pillar 26. The upright opposite surfaces 28 may preferably be configured such that a distance therebetween may be constant over the entire length of the proximal portion of the pillar 26. Conversely, the inclined opposite surfaces 30 may extend from the substantially central portion of the pillar 26 to the distal end 26b of the pillar 26 and terminate in the guide portion 32. The inclined opposite surfaces 30 may preferably be smoothly continuous with the upright opposite surfaces 28. The inclined opposite surfaces 30 may be configured such that a distance therebetween may be gradually reduced upward (i.e., from the substantially central portion of the pillar 26 toward the distal end 26b thereof). That is, the inclined opposite surfaces 30 may respectively be oppositely inclined inward and upward with respect to an axis of the pillar 26 (the engagement leg 24). Further, the distance between the upright opposite surfaces 28 of the pillar 26 may preferably be determined to be slightly smaller than the length of each of the semicircular short sides of the attaching hole 46 (i.e., the distance between the straight long sides of the attaching hole 46), so that the upright opposite surfaces 28 may fit the straight long sides of the attaching hole 46 when the engagement leg 24 fitted into the attaching hole 46 (FIG. 22). Further, the guide portion 32 of the pillar 26 may have an elliptical shape that is substantially similar to the shape of the attaching hole 46. That is, the guide portion 32 may have straight longitudinal (front and rear) sides and semicircular or curved lateral sides corresponding to the straight long sides and the semicircular short sides of the attaching hole 46. In addition, the guide portion 32 may be chamfered or rounded along an entire circumference (i.e., all of the longitudinal sides and the lateral sides) thereof so as to have a tapered guide surface 34 therein. The tapered guide surface 34 thus formed may be inclined with respect to the axis of the pillar 26 and smoothly continuous with the inclined opposite surfaces 30 formed in the pillar 26 (FIG. 8).

As shown in FIGS. 7 and 9, the engagement strips 36 may respectively be oppositely positioned in the lateral sides of the pillar 26 across the pillar 26, so as to be laterally aligned with each other (FIG. 9). Further, the engagement strips 36 may preferably be formed as cantilevered strips and configured to be elastically deformed laterally (toward and away from the pillar 26). In particular, the engagement strips 36 may respectively be connected to lateral sides of the guide portion 32 of the pillar 26 via proximal (upper) ends thereof, so as to be elastically deformed laterally about the proximal ends thereof. The engagement strips 36 may respectively have distal (lower) ends that functions as free ends. Further, the engagement strips 36 may respectively have shoulder portions 36a that are positioned between the proximal and distal ends thereof and are most projected outward. Further, the engagement strips 36 may respectively have multiple (three in this embodiment) stair-like engagement claws 36b that are positioned between the shoulder portions 36a and the distal ends. As will be appreciated, when the engagement leg 24 is inserted into the attaching hole 46 of the body panel 44, one of the engagement claws 36b of each of the engagement strips 36 may engage an inner periphery 46a of the attaching hole 46 depending on the thickness of the body panel 44, so that the engagement leg 24 may be secured to the attaching hole 46 (FIG. 21). Further, the engagement strips 36 may respectively have rounded guide surfaces 36s formed between the proximal ends and the shoulder portions 36a. The guide surfaces 36s may respectively be inclined with respect to the axis of the pillar 26 and have a rounded transverse cross-sectional shape substantially corresponds to the shape of the semicircular short sides of the attaching hole 46 (FIG. 19). The rounded guide surfaces 36s may be smoothly continuous with the tapered guide surface 34 of the guide portion 32.

As described above, the pillar 26 may have the inclined opposite surfaces 30 formed therein. Further, the guide portion 32 of the pillar 26 may have the tapered guide surface 34 that is formed in the circumferential surface thereof. Therefore, the engagement leg 24 can be easily inserted into the attaching hole 46 of the body panel 44 even when the engagement leg 24 is axially obliquely inserted into the attaching hole 46 (i.e., even when the engagement leg 24 is pressed into the attaching hole 46 while the axis of the engagement leg 24 is inclined with respect to an axis of the attaching hole 46).

Further, as previously described, the engagement leg 24 may sometimes be pressed into the attaching hole 46 while the engagement leg 24 is rotationally displaced about the axis of the attaching hole 46. Generally, when the engagement leg 24 of the clip 20 applied to the cable tie 10 is pressed into the attaching hole 46 in order to attach the wiring harness W to the body panel 44, the engagement leg 24 may be rotationally displaced about the axis of the attaching hole 46. In an attempt to allow the engagement leg 24 to be introduced into the attaching hole 46 even in such a case, the engagement leg 24 may have a plurality of (four in this embodiment) relief surfaces 40 formed in the front and rear sides of the pillar 26. As shown in FIG. 11, the relief surfaces 40 may be formed by partially removing the pillar 26 along the outer corner portions 27 (i.e., along the front corner portions of the main portion 26c and the rear corner portions of the wing portions 26d). In particular, as shown in FIG. 7, the relief surfaces 40 may respectively be formed in the pillar 26 so as to extend over the inclined opposite surfaces 30 and the upright opposite surfaces 28 of the pillar 26. That is, the relief surfaces 40 may be formed in the pillar 26 in areas that partially overlap the inclined opposite surfaces 30 and the upright opposite surfaces 28. Further, as shown in FIG. 6, the relief surfaces 40 may respectively be formed by obliquely removing the pillar 26 along cutting planes oblique to the inclined opposite surfaces 30 and the upright opposite surfaces 28 of the pillar 26. Therefore, the relief surfaces 40 may respectively be inclined with respect to the axis of the pillar 26 in different directions from the inclined opposite surfaces 30. That is, the relief surfaces 40 may respectively be inclined with respect to the inclined opposite surfaces 30 about the axis of the pillar 26. Thus, the pillar 26 may include four different inclined surfaces (i.e., the relief surfaces 40) other than the upright opposite surfaces 28 and the inclined opposite surfaces 30. Further, the relief surfaces 40 may respectively be formed in the pillar 26 so as to partially overlap only the inclined opposite surfaces 30.

In order to attach the clip 20 to the body panel 44, the clip 20 may be positioned adjacent to the body panel 44 while the engagement leg 24 (the guide portion 32 of the pillar 26) is axially and rotationally aligned with the attaching hole 46 of the body panel 44. Subsequently, the engagement leg 24 is pressed into the attaching hole 46. As a result, the engagement leg 24 may enter the attaching hole 46 while the engagement strips 36 are elastically flexed inwardly. When the engagement leg 24 reaches a predetermined position in the attaching hole 46, the engagement strips 36 are respectively elastically outwardly restored or spread, so that one of the engagement claws 36b of each of the engagement strips 36 may engage the inner periphery 46a of the attaching hole 46. As a result, the engagement leg 24 may be secured to or fitted into the attaching hole 46, so that the clip 20 can be fixedly connected to the body panel 44

However, when the clip 20 is positioned adjacent to the body panel 44 in order to connect the clip 20 to the body panel 44, the engagement leg 24 (the guide portion 32) may sometimes be rotationally misaligned with the attaching hole 46 i.e., the engagement leg 24 may sometimes be rotationally displaced about an axis of the attaching hole 46. An insertion operation of the clip 20 in such a case will be described with reference to FIGS. 12 to 20.

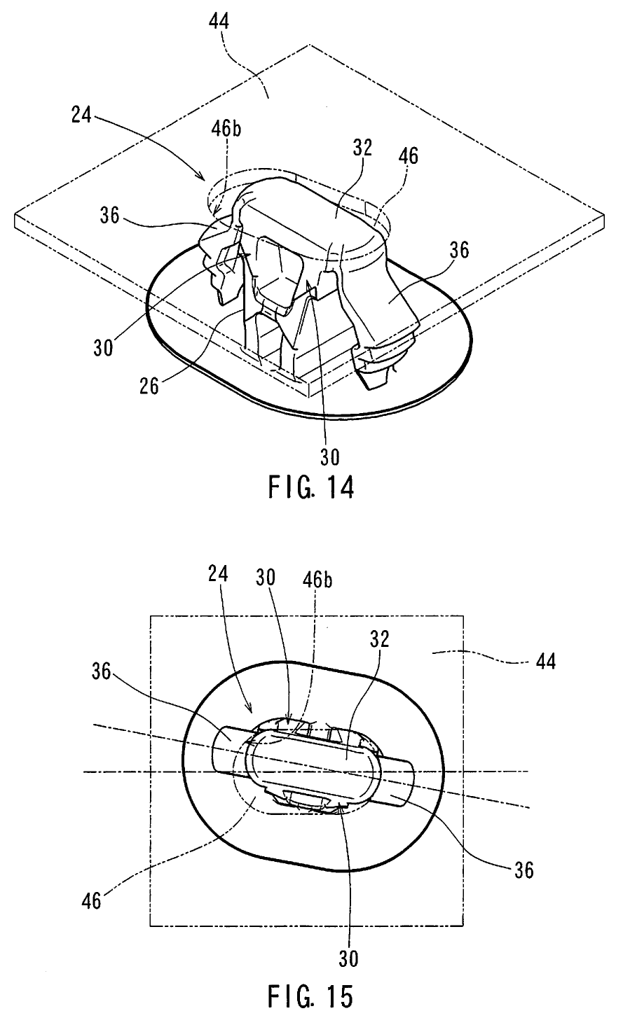

In a condition in which the engagement leg 24 (the guide portion 32) is rotationally misaligned with the attaching hole 46 (a pre-insertion condition) (FIGS. 12 and 13), when the engagement leg 24 of the clip 20 is pressed into the attaching hole 46, the guide portion 32 (the distal end 26b) of the pillar 26 of the engagement leg 24 may be started to be inserted into the attaching hole 46 while serving as a leading end. As a result, as shown in FIGS. 14 and 15, the engagement leg 24 may be successively introduced into the attaching hole 46 while the guide portion 32 interferes with a circumferential surface 46b of the attaching hole 46 because the guide portion 32 may have the tapered guide surface 34 that is formed in the circumferential surface thereof (an initial insertion condition). Thus, the engagement leg 24 may be introduced into the attaching hole 46 while a rotational misalignment or displacement of the engagement leg 24 with respect to the attaching hole 46 is gradually corrected to a certain degree.

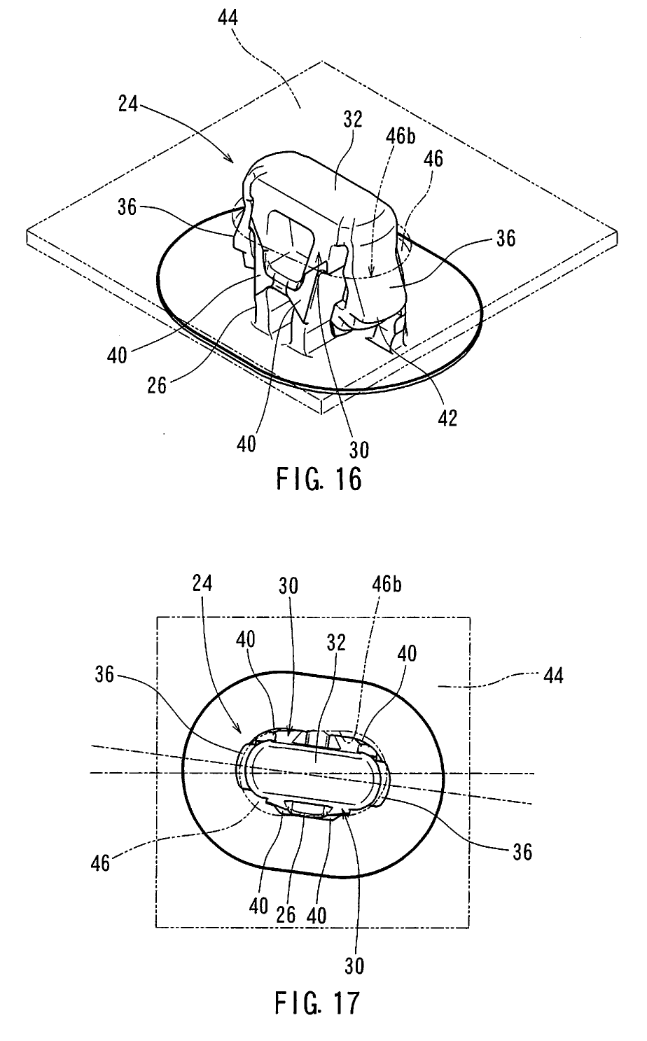

When the engagement leg 24 is further pressed into the attaching hole 46 after the guide portion 32 of the pillar 26 passes through the attaching hole 46, as shown in FIGS. 16 and 17, the engagement leg 24 may be successively introduced into the attaching hole 46 while the inclined opposite surfaces 30 of the pillar 26 interfere with the circumferential surface 46b of the attaching hole 46 (an intermediate insertion condition). At this time, even when an axis of the engagement leg 24 is inclined with respect to an axis of the attaching hole 46, an insertion resistance of the engagement leg 24 may be reduced due to the inclined opposite surfaces 30 while an axial inclination of the engagement leg 24 may be corrected due to the interference of the inclined opposite surfaces 30 with the circumferential surface 46b of the attaching hole 46.

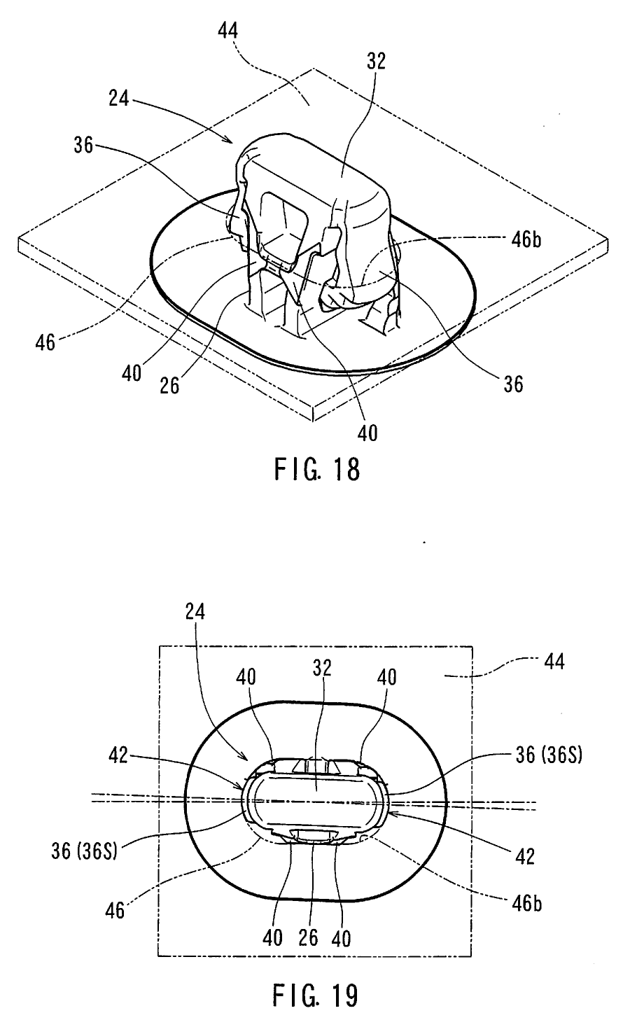

Thereafter, when the engagement leg 24 is further pressed into the attaching hole 46, as shown in FIGS. 18 and 19, the engagement leg 24 may be successively introduced into the attaching hole 46 while the relief surfaces 40 (typically the two relief surfaces 40 positioned diagonally to each other) formed in the pillar 26 may interfere with the circumferential surface 46b of the attaching hole 46 (a final insertion condition). As a result, the engagement leg 24 may be introduced into the attaching hole 46 while the rotational misalignment of the engagement leg 24 with respect to the attaching hole 46 is further corrected due to the interference of the relief surfaces 40 with the circumferential surface 46b of the attaching hole 46.

Subsequently, as shown in FIGS. 20 to 22, the engagement leg 24 is further pressed into the attaching hole 46 until one of the engagement claws 36b of each of the engagement strips 36 may engage the inner periphery 46a of the attaching hole 46 (an insertion completion condition). As a result, the engagement leg 24 may reach an appropriate fitted condition in which the engagement leg 24 is fitted into the attaching hole 46 while the axial inclination and the rotational misalignment of the engagement leg 24 with respect to the attaching hole 46 is substantially corrected. Thus, the engagement leg 24 may be easily introduced into the attaching hole 46 due to the presence of the relief surfaces 40 even when the engagement leg 24 is pressed into the attaching hole 46 in a condition in which the engagement leg 24 is rotationally misaligned with the attaching hole 46.

Further, in the intermediate insertion condition (FIGS. 16 and 17) and the terminal insertion condition (FIGS. 18 and 19) of the engagement leg 24, the engagement leg 24 may be introduced into the attaching hole 46 while the engagement strips 36 are respectively continuously flexed inward with respect to the pillar 26. When the engagement leg 24 is sufficiently inserted into the attaching hole 46, i.e., in the insertion completion condition (FIGS. 20 to 22) of the engagement leg 24, the shoulder portions 36a of the engagement strips 36 may pass through the attaching hole 46. As a result, the engagement leg 24 may be fitted into and retained in the attaching hole 46, so as to reach the fitted condition. In the fitted condition of the engagement leg 24, the engagement strips 36 may respectively be elastically outwardly restored or spread, so that one of the engagement claws 36b of each of the engagement strips 36 may engage the inner periphery 46a of the attaching hole 46 of the body panel 44 (FIG. 21). Thus, the clip 20 can be attached to the body panel 44.

Further, in the fitted condition of the engagement leg 24 shown in FIGS. 20 to 22, the upright opposite surfaces 28 formed in the proximal portion of the pillar 26 may contact the circumferential surface 46b of the attaching hole 46 in the form of substantial surface contact (FIG. 22). That is, the engagement leg 24 completely inserted into the attaching hole 46 may be connected to the body panel 44 while it is effectively prevented from being rattled laterally and back and forth with respect to the attaching hole 46 due to the upright opposite surfaces 28 formed in the proximal portion of the pillar 26 and the engagement strips 36.

### Second Embodiment

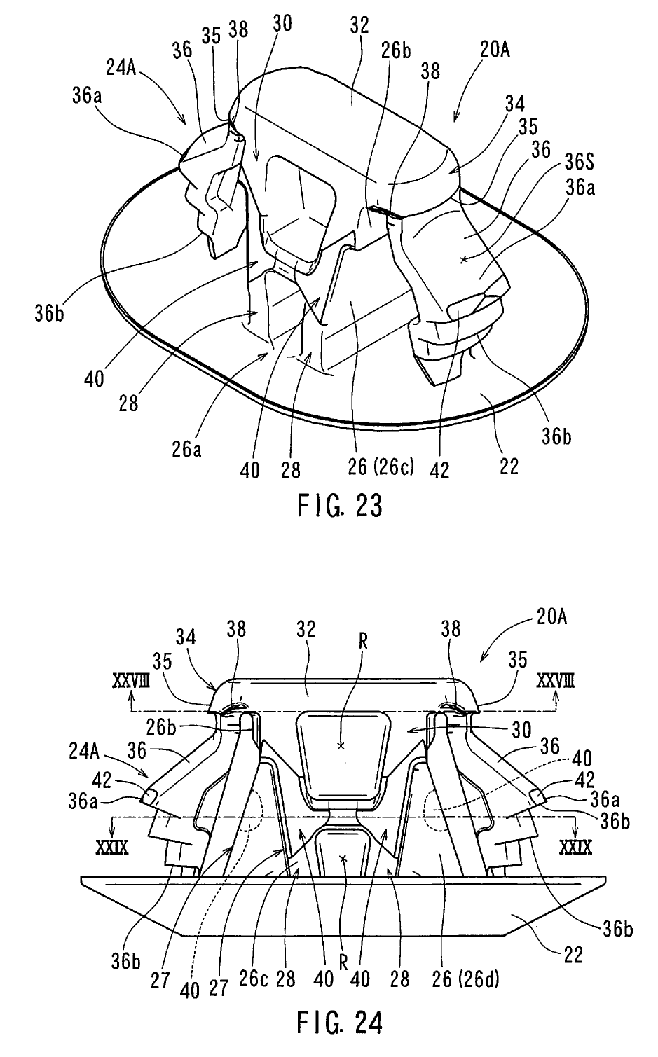

The second detailed representative embodiment will now be described with reference to FIGS. 23 to 40.

Because the second embodiment relates to the first embodiment, only the constructions and elements that are different from the first embodiment will be explained in detail. Elements that are the same in the first and second embodiments will be identified by the same reference numerals and a detailed description of such elements may be omitted.

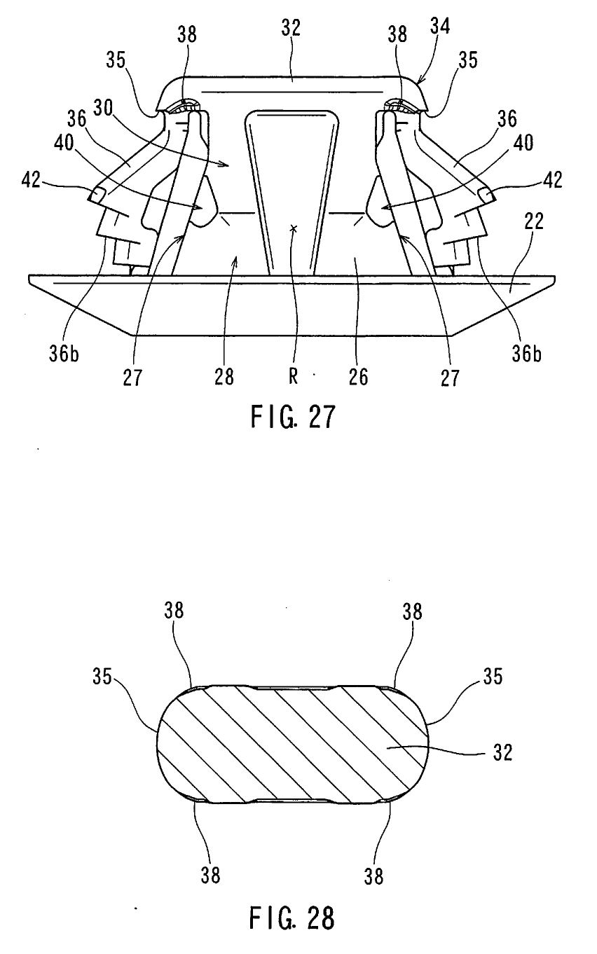

Similar to the clip 20 according to the first embodiment, a clip 20A according to the second embodiment may be applied to a cable tie (not shown) or a cable attachment (not shown). The clip 20A may have an engagement leg 24A similar to the engagement leg 24 of the clip 20 according to the first embodiment. However, unlike the engagement leg 24, in the engagement leg 24A, the guide portion 32 of the pillar 26 may have curved eave-shaped projections 35 that are respectively formed in the curved lateral sides thereof. The eave-shaped projections 35 may be projected outward from the guide portion 32 of the pillar 26 so as to hang over the engagement strips 36 that are respectively connected to the lateral sides of the guide portion 32 (FIGS. 24 and 27). In other words, the engagement strips 36 may respectively be connected to the lateral sides of the guide portion 32 along lower surfaces of the eave-shaped projections 35. Thus, the connecting portions of the engagement strips 36 and the pillar 26 may respectively be covered by the eave-shaped projections 35. Therefore, when the engagement leg 24A is pressed into the attaching hole 46 of the body panel 44, the guide portion 32 of the pillar 26 can be smoothly introduced into the attaching hole 46.

Further, as shown in FIGS. 23 to 28, the engagement leg 24A may additionally have a plurality of (four in this embodiment) relief surfaces 38 formed in the guide portion 32 of the pillar 26 and a plurality of (four in this embodiment) relief surfaces 42 formed in the engagement strips 36. The relief surfaces 38 may be formed by partially cutting off or removing lower corner peripheries of the eave-shaped projections 35 of the guide portion 32 obliquely upward. In particular, as shown in FIGS. 24 and 27, the relief surfaces 38 may respectively be formed in the lower corner peripheries of the eave-shaped projections 35 so as to extend over the tapered guide surface 34 of the guide portion 32. Further, the relief surfaces 38 may respectively be formed by obliquely removing the lower corner peripheries of the eave-shaped projections 35 along cutting planes oblique to the tapered guide surface 34. Therefore, the relief surfaces 38 may respectively be inclined with each other and inclined with respect to the axis of the pillar 26 in different directions from the tapered guide surface 34. That is, the relief surfaces 38 may respectively be inclined with each other and inclined with respect to the tapered guide surface 34 about the axis of the pillar 26. Thus, the guide portion 32 (the pillar 26) may have four different surfaces (i.e., the relief surfaces 38) other than the tapered guide surface 34. Conversely, the relief surfaces 42 may be formed in the shoulder portions 36a of the engagement strips 36 two by two by partially obliquely cutting off or removing outer corner portions of the shoulder portions 36a. That is, the relief surfaces 42 may be formed in the shoulder portions 36a of the engagement strips 36 so as to extend over the guide surfaces 36s. That is, the relief surfaces 42 may be formed in the shoulder portions 36a in areas that partially overlap the guide surfaces 36s. Further, as shown in FIG. 23, the relief surfaces 42 may respectively be formed by obliquely removing the shoulder portions 36a along cutting planes oblique to the guide surfaces 36s. Therefore, the relief surfaces 42 may respectively be inclined with each other and inclined with respect to the axis of the pillar 26 in different directions from the guide surfaces 36s. That is, the relief surfaces 42 may respectively be inclined with each other and inclined with respect to the guide surfaces 36s about the axis of the pillar 26. Thus, the engagement strips 36 may include four different inclined surfaces (i.e., the relief surfaces 42) other than the rounded guide surfaces 36s. Further, the relief surfaces 42 of each of the engagement strips 36 may preferably be formed in symmetry with respect to an axis of each of the engagement strips 36.

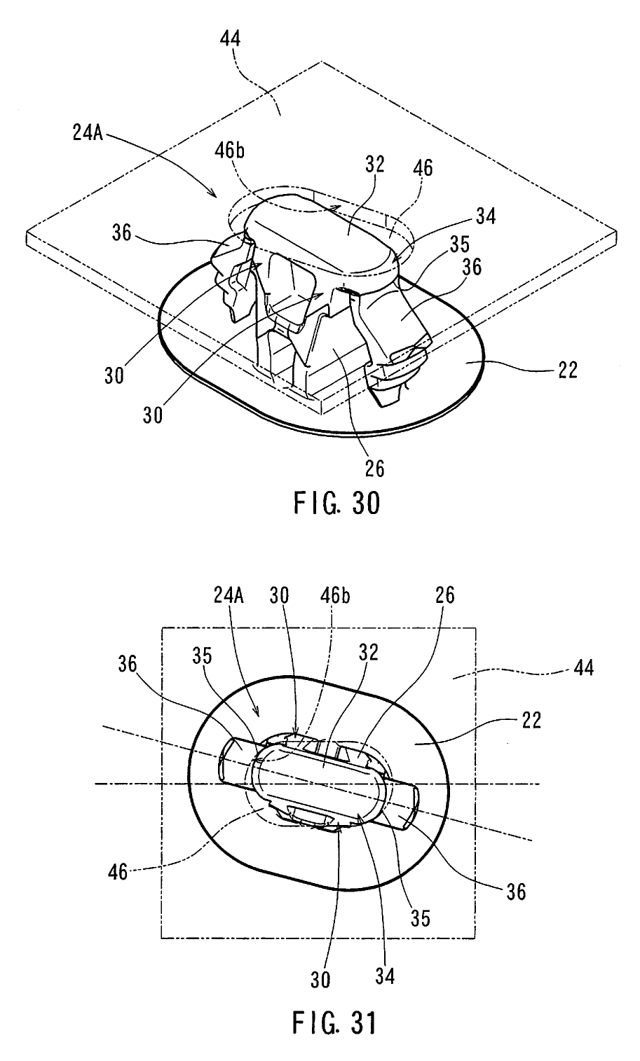

The clip 20A thus constructed may be used to attach a wiring harness (not shown) to the body panel 44. However, similar to the first embodiment, when the clip 20A is positioned adjacent to the body panel 44 in order to connect the clip 20A to the body panel 44, the engagement leg 24A (the guide portion 32) may sometimes be rotationally misaligned with the attaching hole 46, i.e., the engagement leg 24A may sometimes be rotationally displaced about the axis of the attaching hole 46. An insertion operation of the clip 20A in such a case will be hereinafter described with reference to FIGS. 30 to 39.

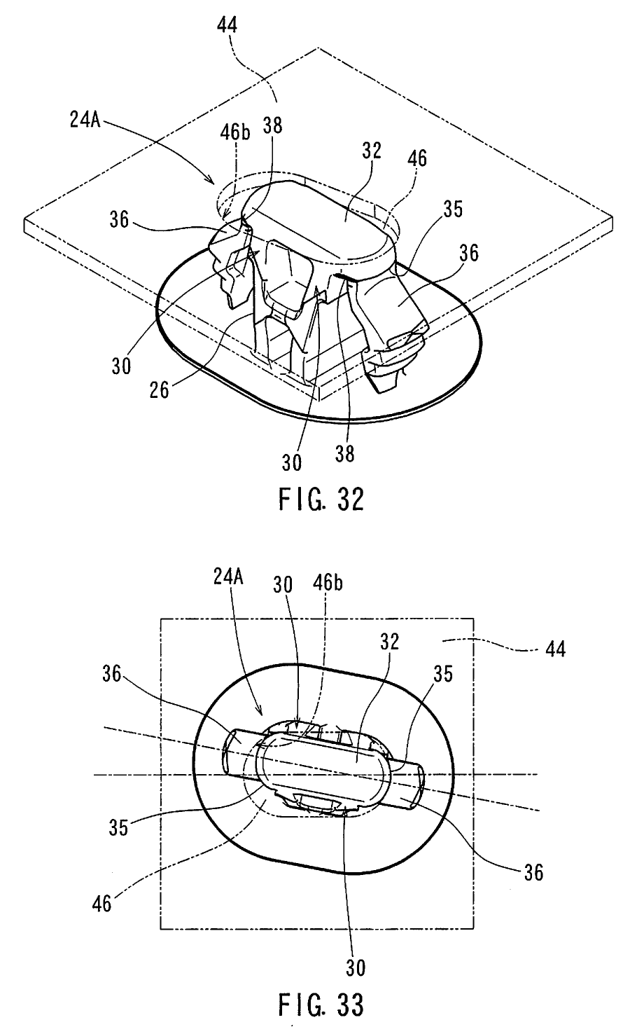

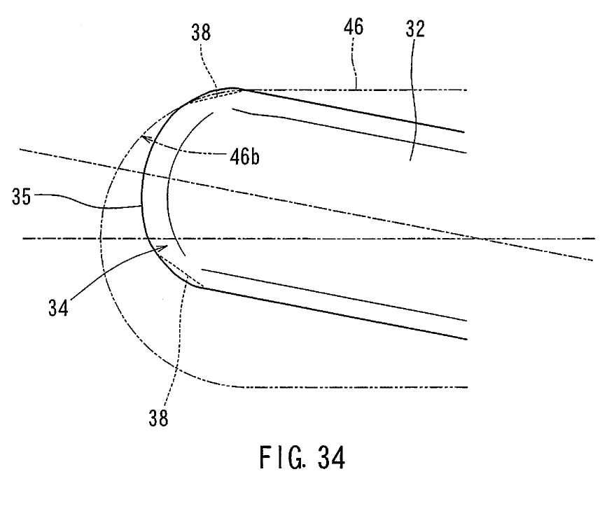

In a condition in which the engagement leg 24A (the guide portion 32) is rotationally misaligned with the attaching hole 46 (a pre-insertion condition) (FIGS. 30 and 31), when the engagement leg 24A of the clip 20A is pressed into the attaching hole 46, the guide portion 32 having the eave-shaped projections 35 may be started to be inserted into the attaching hole 46 while serving as a leading end (FIGS. 30 and 31). As a result, as shown in FIGS. 32 to 34, the engagement leg 24A may be successively inserted into the attaching hole 46 while the guide portion 32 and the eave-shaped projections 35 formed therein interfere with a circumferential surface 46b of the attaching hole 46 (an initial insertion condition). Thus, the engagement leg 24A may be introduced into the attaching hole 46 while a rotational misalignment of the engagement leg 24A with respect to the attaching hole 46 is gradually corrected to a certain degree. At this time, the relief surfaces 38 formed in the eave-shaped projections 35 (typically the two relief surfaces 38 positioned diagonally to each other) may move along the circumferential surface 46b of the attaching hole 46 (FIG. 34), so as to reduce the insertion resistance of the engagement leg 24A caused by the interference of the guide portion 32 (the eave-shaped projections 35) with the circumferential surface 46b.

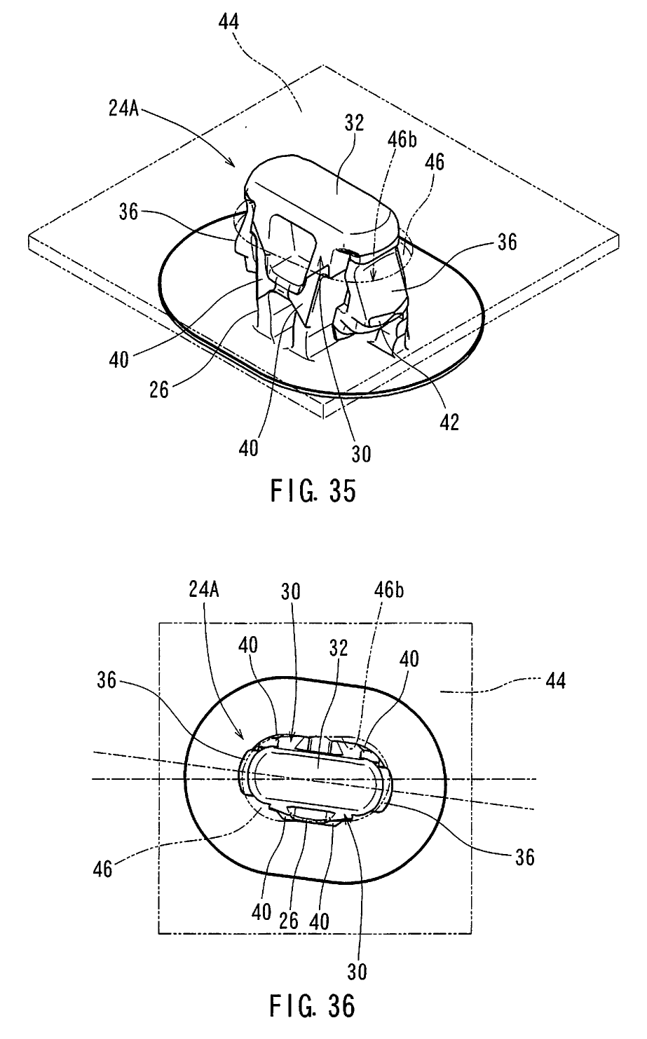

Thereafter, when the engagement leg 24A is further pressed into the attaching hole 46 after the guide portion 32 of the pillar 26 passes through the attaching hole 46, as shown in FIGS. 35 and 36, similar to the clip 20 according to the first embodiment, the engagement leg 24A may be successively introduced into the attaching hole 46 while the inclined opposite surfaces 30 of the pillar 26 interfere with the circumferential surface 46b of the attaching hole 46 (an intermediate insertion condition).

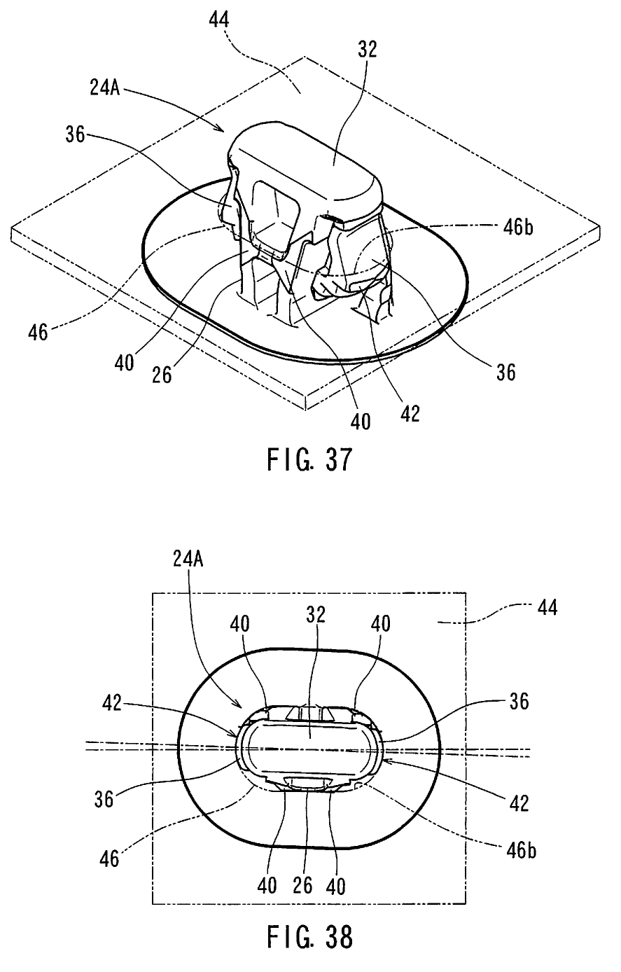

As shown in FIGS. 37 and 38, when the engagement leg 24A is further pressed into the attaching hole 46, the engagement leg 24A may be successively introduced into the attaching hole 46 while the relief surfaces 40 (typically the two relief surfaces 40 positioned diagonally to each other) formed in the pillar 26 may interfere with the circumferential surface 46b of the attaching hole 46 (a final insertion condition). As a result, the engagement leg 24A may be introduced into the attaching hole 46 while the rotational misalignment of the engagement leg 24A with respect to the attaching hole 46 is further corrected.

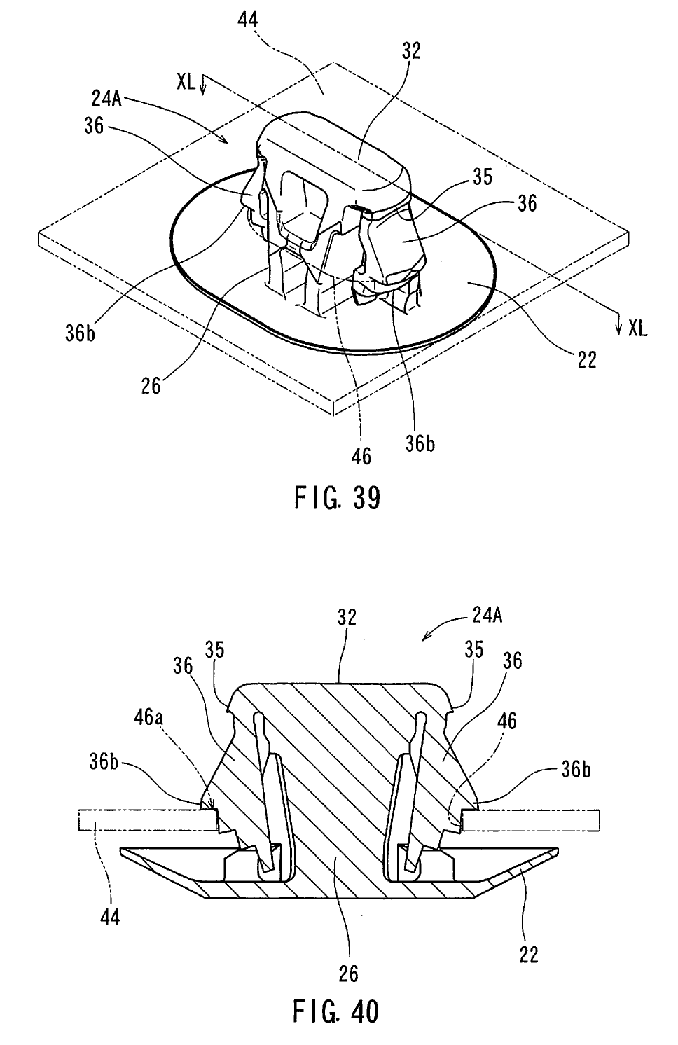

Subsequently, as shown in FIGS. 39 and 40, the engagement leg 24A is further pressed into the attaching hole 46 until one of the engagement claws 36b of each of the engagement strips 36 may engage the inner periphery 46a of the attaching hole 46 (an insertion completion condition). As a result, the engagement leg 24A may reach an appropriate fitted condition in which the engagement leg 24A is fitted into the attaching hole 46 while the rotational misalignment of the engagement leg 24A with respect to the attaching hole 46 is substantially corrected.

Further, in this embodiment, as shown in FIGS. 37 and 38, when the shoulder portions 36a of the engagement strips 36 pass through the attaching hole 46, i.e., in the terminal insertion condition, the relief surfaces 42 formed in the engagement strips 36 (typically the two relief surfaces 42 positioned diagonally to each other) may interfere with the circumferential surface 46b of the attaching hole 46. The interference of the relief surfaces 42 with the circumferential surface 46b may also function to correct the rotational misalignment of the engagement leg 24A with respect to the attaching hole 46.

### Third Embodiment

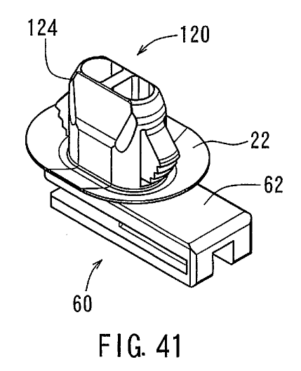

The third detailed representative embodiment will now be described with reference to FIGS. 41 to 45.

Because the third embodiment relates to the first embodiment, only the constructions and elements that are different from the first embodiment will be explained in detail. Elements that are the same in the first and third embodiments will be identified by the same reference numerals and a detailed description of such elements may be omitted.

As shown in FIG. 41, a clip 120 according to the third embodiment may be applied to a component attachment 60 that is used to attach a vehicle component (not shown) other than a wiring harness to a body panel. Similar to the cable tie 10 and the cable attachment 50 and 50A to which the clip 20 according to the first embodiment is applied, the component attachment 60 may preferably be integrally formed as a unit by injection molding of a resinous material. The component attachment 60 may include an attachment base 62 (a holding member) to which the clip 120 is integrally connected. The attachment base 62 may be configured to be coupled to the vehicle component.

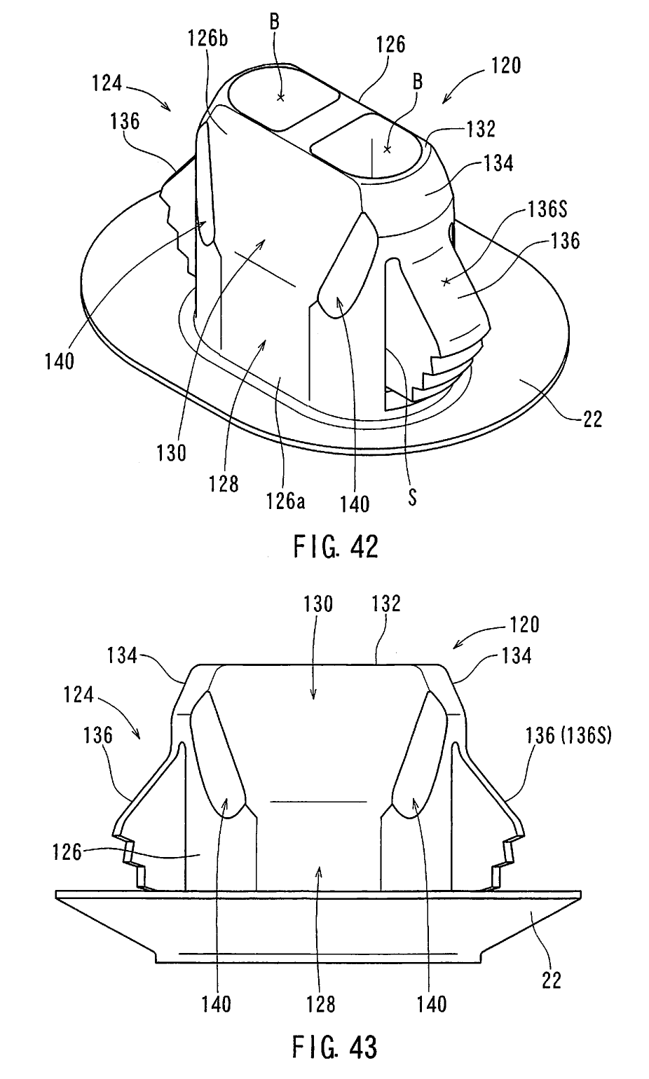

Next, the clip 120 will be described in detail with reference to FIGS. 42 to 45. Further, in FIGS. 42 to 45, the attachment base 62 may be omitted. Similar to the clip 20, the clip 120 may include a dish-shaped stabilizer 22 and an engagement leg 124. The engagement leg 124 may be composed of a pillar 126 and a pair of engagement strips 136. Further, the pillar 126 may have a guide portion 132 formed in a distal end thereof and having a tapered guide surface 134.

As shown in FIGS. 42 and 45, the pillar 126 of the engagement leg 124 may be an elliptical columnar-shaped member having lightening bores B formed therethrough. That is, the pillar 126 may be formed as a hollow member having front and rear sides (a first pair of opposite sides) and right and left or lateral sides (a second pair of opposite sides).

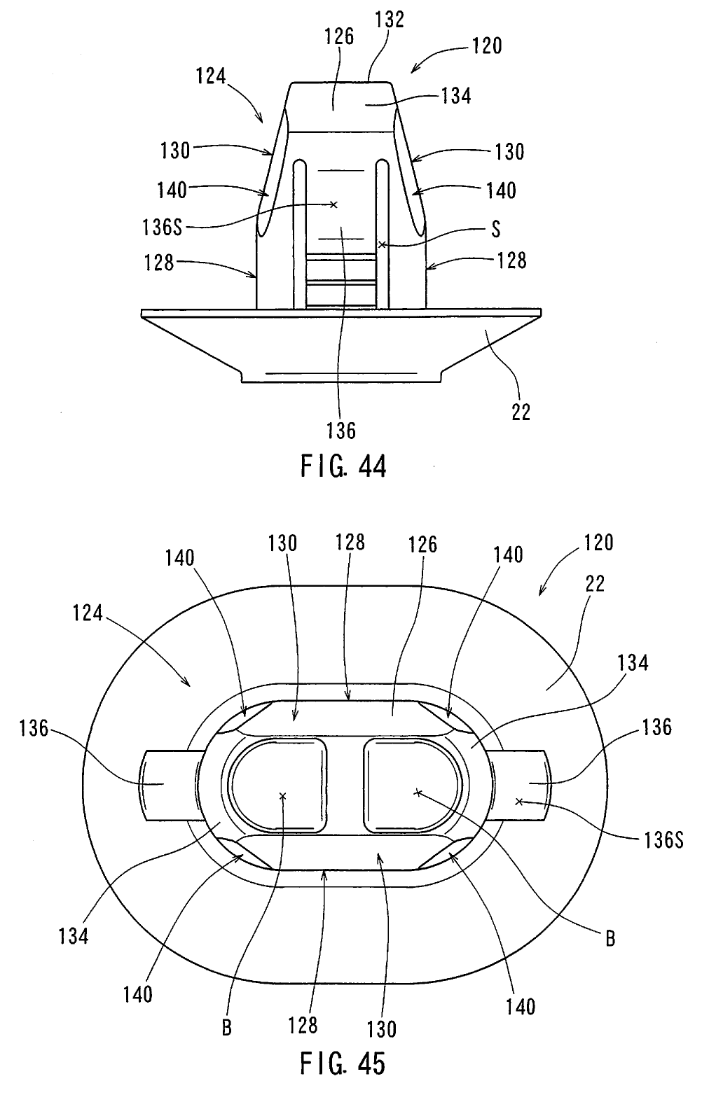

Further, as shown in FIG. 44, the pillar 126 may have front and rear vertical or upright (first) surfaces 128 and front and rear inclined (second) surfaces 130. The front and rear upright opposite surfaces 128 may respectively be formed in the front and rear sides of the pillar 126 so as to extend along a lower or proximal portion of the pillar 126 (a certain portion adjacent to a proximal end 126a of the pillar 126). The front and rear inclined opposite surfaces 130 may respectively be formed in the front and rear sides of the pillar 126 so as to extend along an upper or distal portion of the pillar 126 (a certain portion adjacent to a distal end 126b of the pillar 126). In particular, the upright opposite surfaces 128 may extend from the proximal end 126a of the pillar 126 to a substantially central portion of the pillar 126. Conversely, the inclined opposite surfaces 130 may extend from the substantially central portion of the pillar 126 to the guide portion 132. The inclined opposite surfaces 130 may preferably be continuous with the upright opposite surfaces 128. However, as shown in FIGS. 42 to 45, unlike the inclined opposite surfaces 30 of the first embodiment, the inclined opposite surfaces 130 may extend over the guide portion 132. That is, the inclined opposite surfaces 130 may divide the tapered guide surface 134 of the guide portion 132 into two (right and left) parts. As a result, the tapered guide surface 134 may be interrupted in the front and rear sides of the pillar 126. Further, the lateral sides of the pillar 126 may be shaped to have semicircular or curved surfaces.

Similar to the first embodiment, the engagement leg 124 may have a plurality of (four in this embodiment) relief surfaces 140 formed in the pillar 126. As shown in FIG. 45, the relief surfaces 140 may be formed by partially removing the pillar 126. In particular, as shown in FIG. 45, the relief surfaces 140 may respectively be formed in the pillar 126 so as to extend over the inclined opposite surfaces 130. That is, the relief surfaces 140 may be formed in the pillar 126 in areas that partially overlap the inclined opposite surfaces 130. Thus, the pillar 126 may include four different inclined surfaces (i.e., the relief surfaces 140) other than the upright opposite surfaces 128 and the inclined opposite surfaces 130. Further, the relief surfaces 140 may be formed in the pillar 126 in areas that partially overlap both of the upright opposite surfaces 128 and the inclined opposite surfaces 130.

As shown in FIGS. 42 and 44, similar to the engagement strips 36 of the first embodiment, the engagement strips 136 may respectively be connected to both lateral sides of the guide portion 132 of the pillar 126 via proximal (upper) ends thereof. Further, the engagement strips 136 may respectively have guide surfaces 136s corresponding to the guide surfaces 36s formed in the engagement strips 36 of the first embodiment. However, the engagement strips 136 may respectively be formed as a part of the hollow pillar 126. That is, the pillar 126 may have U-shaped slots S formed in the lateral sides thereof such that the engagement strips 136 may be defined by the slots S. The engagement strips 136 thus formed may flex inward and outward through the slots S.

### Fourth Embodiment

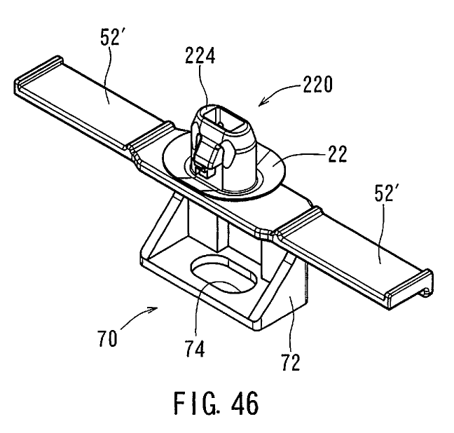

The fourth detailed representative embodiment will now be described with reference to FIGS. 46 to 50.

Because the fourth embodiment relates to the third embodiment, only the constructions and elements that are different from the third embodiment will be explained in detail. Elements that are the same in the third and fourth embodiments will be identified by the same reference numerals and a detailed description of such elements may be omitted.

As shown in FIG. 46, a clip 220 according to the fourth embodiment may be applied to a multiply connectable cable attachment 70. Similar to the cable attachment 50 shown in FIG. 4, the multiply connectable cable attachment 70 may include an elongated plate-shaped attachment base 52′. Further, the multiply connectable cable attachment 70 may include a connecting block 72 that is integrated with the attachment base 52′. The connecting block 72 may have an attaching hole 74 into which an engagement leg of another clip (not shown) is inserted.

According to the multiply connectable cable attachment 70, the clip 220 may be attached to two wiring harnesses (not shown). In order to attach the clip 220 to the wiring harnesses, similar to the case of the cable attachment 50, the attachment base 52′ of the multiply connectable cable attachment 70 may be secured to one of the wiring harnesses using a tape. As a result, the multiply connectable cable attachment 70 may be integrated with one of the wiring harnesses, so that the clip 220 may be attached to one of the wiring harnesses. Thereafter, an engagement leg of another clip (e.g., the clip 20 of the cable tie 10) connected to the other of the wiring harnesses may be inserted into the attaching hole 74 of the connecting block 72. Thus, the clip 220 of the multiply connectable cable attachment 70 may be attached to or integrated with the two wiring harnesses.

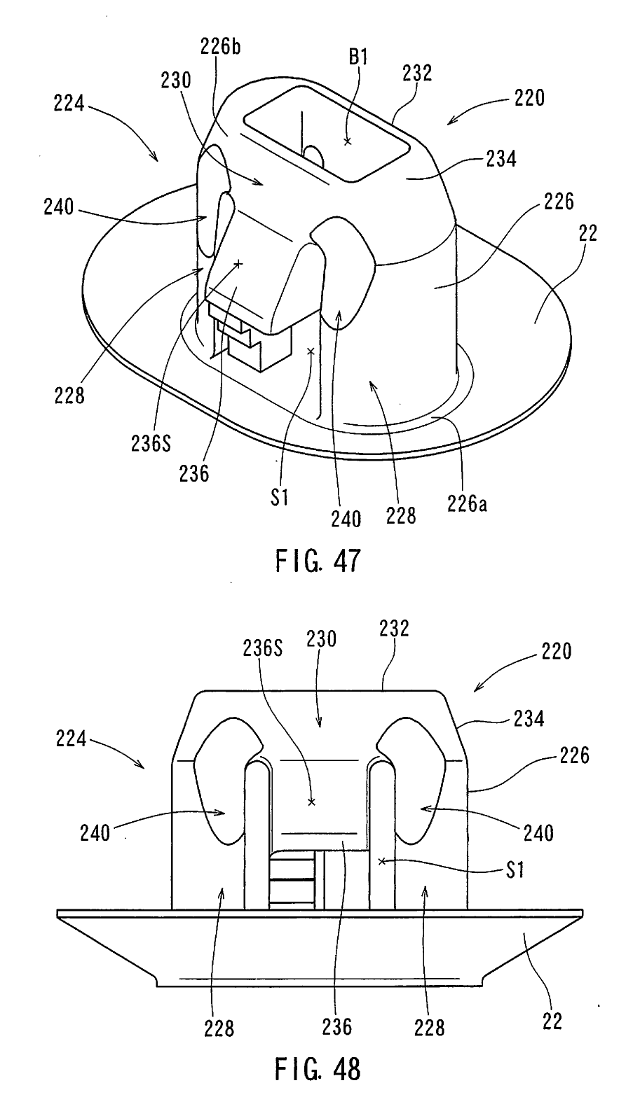

Next, the clip 220 will be described in detail with reference to FIGS. 47 to 50. Further, in FIGS. 46 to 50, the attachment base 52′ and the connecting block 72 may be omitted. Similar to the clip 120, the clip 220 may include a dish-shaped stabilizer 22 and an engagement leg 224. The engagement leg 224 may be composed of a pillar 226 and a pair of engagement strips 236. Further, the pillar 226 may have a guide portion 232 formed in a distal end 226b thereof and having a tapered guide surface 234.

As shown in FIGS. 47 and 50, the pillar 226 of the engagement leg 224 may be an elliptical columnar-shaped member having a lightening bore B1 formed therethrough. That is, the pillar 226 may be formed as a hollow member having front and rear sides (a first pair of opposite sides) and right and left or lateral sides (a second pair of opposite sides).

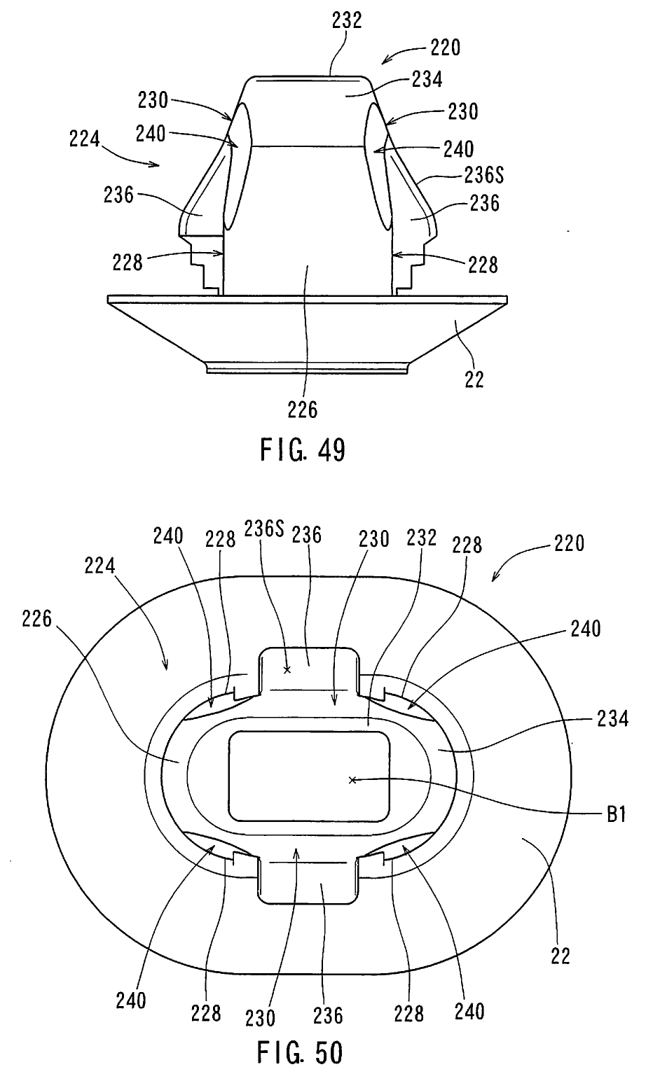

Further, as shown in FIG. 49, the pillar 226 may have front and rear vertical or upright (first) surfaces 228 and front and rear inclined (second) surfaces 230. The front and rear upright opposite surfaces 228 may respectively be formed in the front and rear sides of the pillar 226 so as to extend along a lower or proximal portion of the pillar 226 (a certain portion adjacent to a proximal end 226a of the pillar 226). Further, the front and rear inclined opposite surfaces 230 may respectively be formed in the front and rear sides of the pillar 226 so as to extend along an upper or distal portion of the pillar 226 (a certain portion adjacent to the distal end 226b of the pillar 226). In particular, the upright opposite surfaces 228 may extend from the proximal end 226a of the pillar 226 to a substantially central portion of the pillar 226. Conversely, the inclined opposite surfaces 230 may extend from the substantially central portion of the pillar 226 to the guide portion 232. However, as shown in FIGS. 47 to 50, unlike the inclined opposite surfaces 130 of the third embodiment, the inclined opposite surfaces 230 may substantially be formed as common surfaces with the tapered guide surface 234. Further, the lateral sides of the pillar 226 may be shaped to have semicircular or curved surfaces.

As shown in FIGS. 47 and 48, unlike the engagement strips 136 of the third embodiment, the engagement strips 236 may respectively be oppositely positioned in longitudinal (front and rear) sides of the guide portion 232 of the pillar 226 across the pillar 226 so as to be aligned with each other in a front-back direction (FIG. 50). Further, the engagement strips 36 may preferably be formed as cantilevered strips and configured to be elastically deformed in the front-back direction. Further, the engagement strips 236 may respectively be formed as a part of the hollow pillar 226. That is, the pillar 226 may have U-shaped slots S1 formed in the front and rear sides thereof such that the engagement strips 236 may be defined by the slots S1. The engagement strips 236 may flex inward and outward through the slots S1. Further, unlike the engagement strips 136, the engagement strips 236 may respectively have flattened guide surfaces 236s. Each of the guide surfaces 236s may have a linear transverse cross-sectional shape substantially corresponds to the shape of each of the straight long sides of the attaching hole (not shown). The guide surfaces 236s may be smoothly continuous with the inclined opposite surfaces 230 of the pillar.

Similar to the third embodiment, the engagement leg 224 may have a plurality of (four in this embodiment) relief surfaces 240 formed in the pillar 226. As shown in FIG. 50, the relief surfaces 240 may be formed by partially removing the pillar 226. In particular, as shown in FIG. 50, the relief surfaces 240 may respectively be formed in the pillar 226 so as to extend over the upright opposite surfaces 228 and the inclined opposite surfaces 230. That is, the relief surfaces 240 may be formed in the pillar 226 in areas that partially overlap the upright opposite surfaces 228 and the inclined opposite surfaces 230. Thus, the pillar 226 may include four different inclined surfaces (i.e., the relief surfaces 240) other than the upright opposite surfaces 228 and the inclined opposite surfaces 230.

### Fifth Embodiment

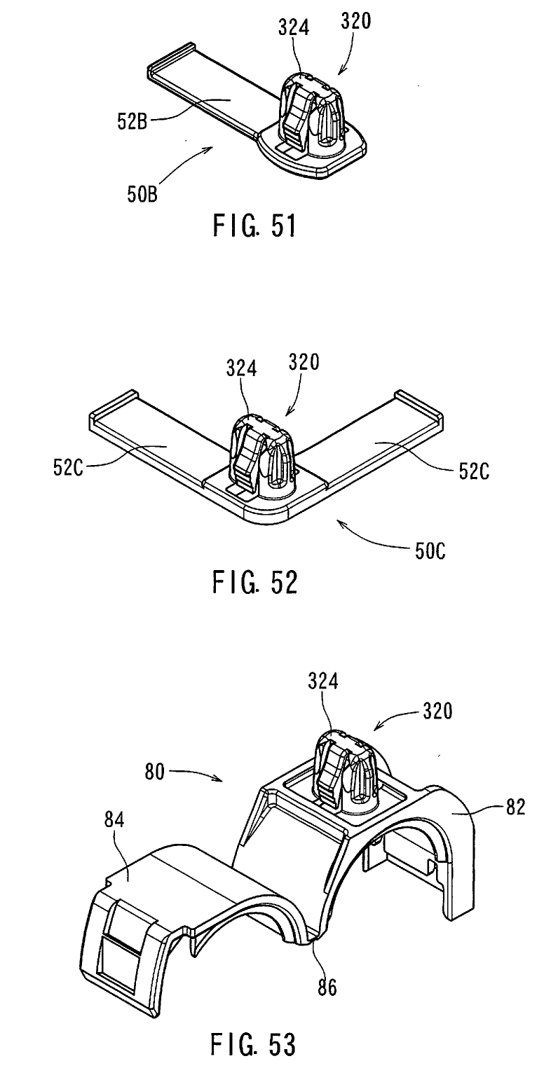

The fifth detailed representative embodiment will now be described with reference to FIGS. 51 to 57.

Because the fifth embodiment relates to the fourth embodiment, only the constructions and elements that are different from the fourth embodiment will be explained in detail. Elements that are the same in the fourth and fifth embodiments will be identified by the same reference numerals and a detailed description of such elements may be omitted.

As shown in FIGS. 51 and 52, a clip 320 according to the fifth embodiment may be applied to a cable attachment 50B and a cable attachment 50C. As described in the first and second embodiment, the cable attachment 50B may include an elongated plate-shaped attachment base 52B (a holding member) to which the clip 320 is connected (FIG. 51). The attachment base 52B may be configured to be secured to a wiring harness (not shown) using a tape. Similarly, the cable attachment 50C may include an angled elongated plate-shaped attachment base 52C (a holding member) to which the clip 320 is connected (FIG. 52). The attachment base 52C may also be configured to be secured to a wiring harness (not shown) using a tape.

Further, as shown in FIG. 53, the clip 320 may be applied to a corrugated tube clamp 80 that is used to attach a corrugated tube (not shown) to a body panel (not shown). The corrugated tube clamp 80 may include a clamp body. The clamp body may be composed of a fixed semicircular clamping portion 82 to which the clip 320 is integrally connected and a movable semicircular clamping portion 84 that is connected to the fixed clamping body 82 via a hinge 86. The fixed clamping portion 82 and the movable clamping portion 84 may be shaped to clamp the corrugated tube therebetween. When the corrugated tube is clamped between the fixed clamping portion 82 and the movable clamping portion 84, the corrugated tube clamp 80 is attached to the corrugated tube. Thus, the clip 320 may be attached to the corrugated tube.

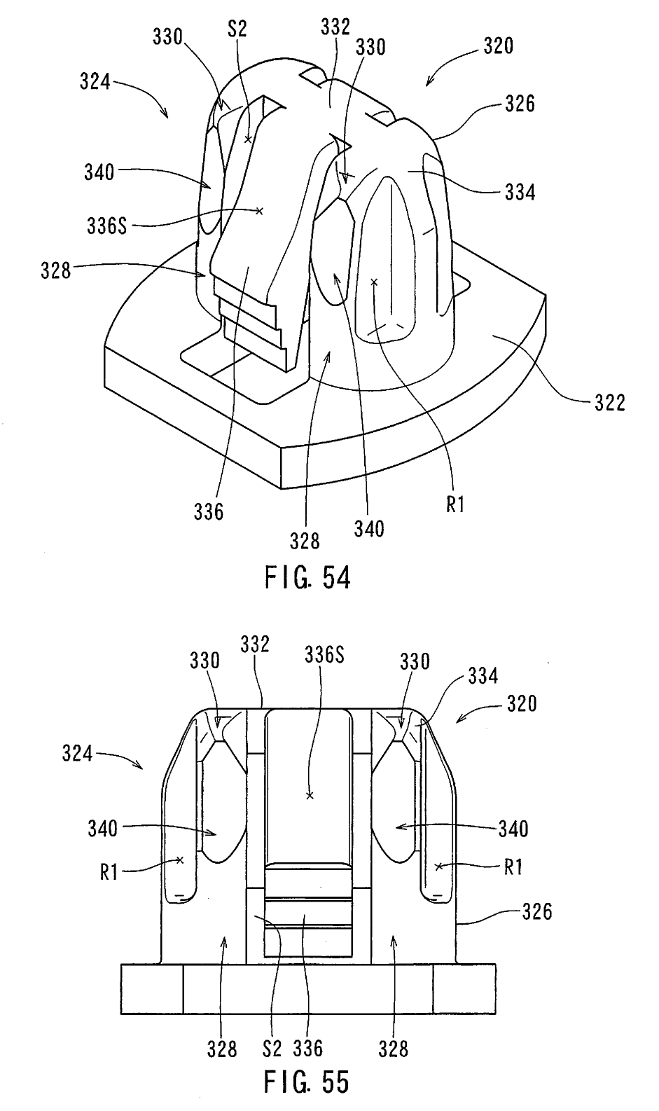

Next, the clip 320 will be described in detail with reference to FIGS. 54 to 57. Further, in FIGS. 54 to 57, the attachment base 52B of the cable attachment SOB, the attachment base 52C of the cable attachment 50C or the clamp body of the corrugated tube clamp 80 may be omitted. The clip 320 may include a disk-shaped clip base 322 and an engagement leg 324. Similar to the clip 220 in the fourth embodiment, the engagement leg 324 may be composed of a pillar 326 and a pair of engagement strips 336. Further, the pillar 326 may have a guide portion 332 formed in a distal end thereof and having a tapered guide surface 334.

As shown in FIGS. 54 and 57, similar to the pillar 226 of the engagement leg 224 in the fourth embodiment, the pillar 326 of the engagement leg 324 may be an elliptical columnar-shaped member having front and rear sides and lateral sides. However, unlike the pillar 226, the pillar 326 may be formed as a substantially solid member having lightening recesses R1 formed in the lateral sides thereof. Further, the pillar 326 may have U-shaped slots S2 formed in the front and rear sides thereof such that the engagement strips 336 may be defined by the slots S2. Unlike the slots S1 formed in the pillar 226, the slots S2 may extend to the guide portion 332. As a result, the slots S2 (and the engagement strips 336 defined therebetween) may separate the tapered guide surface 334 of the guide portion 332.

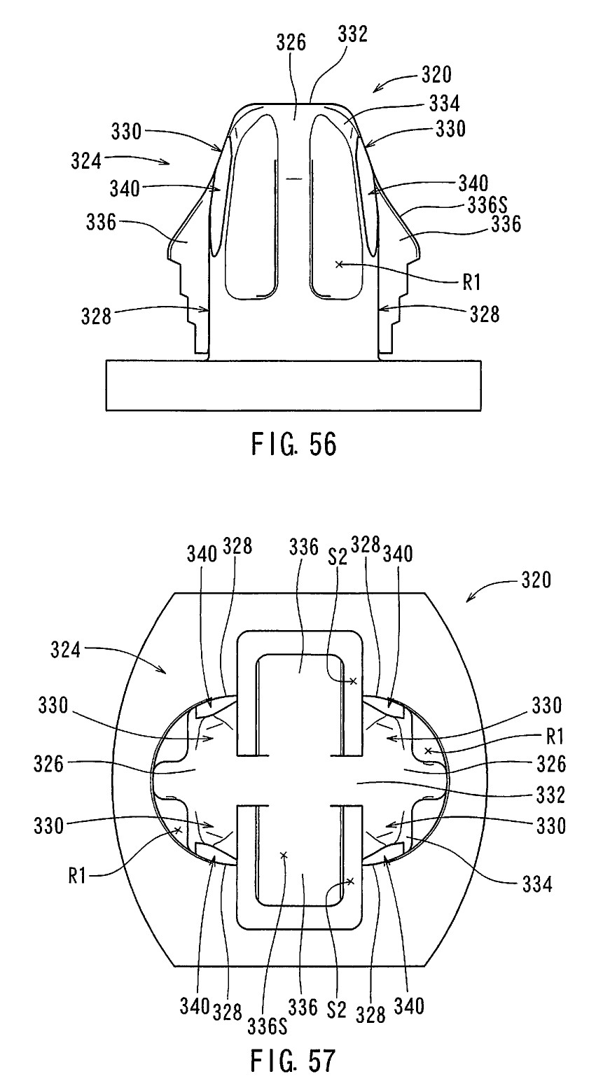

Further, as shown in FIG. 56, similar to the pillar 226 in the fourth embodiment, the pillar 326 may have front and rear vertical or upright (first) surfaces 328 and front and rear inclined (second) surfaces 330. The front and rear upright opposite surfaces 328 may respectively be formed in the front and rear sides of the pillar 326 so as to extend along a lower or proximal portion of the pillar 326. Further, the front and rear inclined opposite surfaces 330 may respectively be formed in the front and rear sides of the pillar 326 so as to extend along an upper or distal portion of the pillar 326. As shown in FIGS. 54 to 57, the inclined opposite surfaces 330 may substantially be formed as common surfaces with the tapered guide surface 334 of the guide portion 332. However, as shown in FIGS. 54 and 55, unlike the inclined opposite surfaces 230 of the fourth embodiment, the inclined opposite surfaces 330 may substantially be separated by the slots S2 (or the engagement strips 336). Further, the lateral sides of the pillar 326 may be shaped to have semicircular or curved surfaces that are formed in the lateral sides thereof.

As shown in FIGS. 54 and 55, similar to the engagement strips 236 of the fourth embodiment, the engagement strips 336 may respectively be connected to longitudinal (front and rear) sides of the guide portion 332 of the pillar 326 via proximal (upper) ends thereof. Further, the engagement strips 336 may respectively have guide surfaces 336s corresponding to the guide surfaces 236s formed in the engagement strips 236 of the fourth embodiment.

Similar to the fourth embodiment, the engagement leg 324 may have a plurality of (four in this embodiment) relief surfaces 340 formed in the pillar 326. As shown in FIG. 57, the relief surfaces 340 may be formed by partially removing the pillar 326. In particular, as shown in FIGS. 54 and 55, the relief surfaces 340 may respectively be formed in the pillar 326 so as to extend over the upright opposite surfaces 328 and the inclined opposite surfaces 330. That is, the relief surfaces 340 may be formed in the pillar 326 in areas that partially overlap the upright opposite surfaces 328 and the inclined opposite surfaces 330. Thus, the pillar 326 may include four different inclined surfaces (i.e., the relief surfaces 340) other than the upright opposite surfaces 328 and the inclined opposite surfaces 330.

Representative examples have been described in detail with reference to the attached drawings. This detailed description is merely intended to teach a person of skill in the art further details for practicing preferred aspects of the present disclosure and is not intended to limit the scope of the disclosure. Only the claims define the scope of the disclosure. Therefore, combinations of features and steps disclosed in the foregoing detail description may not be necessary to practice the disclosure in the broadest sense, and are instead taught merely to particularly describe detailed representative examples. Moreover, the various features taught in this specification may be combined in ways that are not specifically enumerated in order to obtain additional useful embodiments.

What is claimed is:

1. A clip comprising an engagement leg, wherein the engagement leg comprises a pillar having a first pair of opposite sides and a second pair of opposite sides, and a pair of engagement strips respectively oppositely positioned across the pillar and configured to be elastically deformed toward and away from the pillar,
wherein the pillar has first opposite surfaces that are respectively formed in the first pair of opposite sides of the pillar so as to extend along a portion adjacent to a proximal end of the pillar, second opposite surfaces that are respectively formed in the first pair of opposite sides of the pillar so as to extend along a portion adjacent to a distal end of the pillar, and a plurality of first relief surfaces formed in the first pair of opposite sides of the pillar, and
wherein the first relief surfaces respectively partially overlap at least the second opposite surfaces and are inclined with respect to at least the second opposite surfaces about an axis of the pillar.

2. The clip as defined in claim 1, wherein the first relief surfaces respectively partially overlap both of the first and second opposite surfaces.

3. The clip as defined in claim 1, wherein each of the engagement strips has a shoulder portion that is most projected outward, and wherein each of the engagement strips has a pair of second relief surfaces that are formed therein along a periphery of the shoulder portion thereof.

4. The clip as defined in claim 3, wherein the pair of second relief surfaces are inclined with each other about the axis of the pillar.

5. The clip as defined in claim 1, wherein the pillar has a guide portion having a pair of eave-shaped projections that are respectively configured to hang over the engagement strips, and wherein each of the eave-shaped projections has a pair of third relief surfaces that are formed in both end portions thereof.

6. The clip as defined in claim 5, wherein the pair of third relief surfaces are respectively inclined with each other about the axis of the pillar.

7. The clip as defined in claim 1, wherein the first relief surfaces respectively partially overlap only the second opposite surfaces.

8. The clip as defined in claim 1, wherein the first pair of opposite sides and the second pair of opposite sides of the pillar respectively correspond to front and rear sides and lateral sides of the pillar, wherein the pillar has a rectangular columnar main portion and a pair of wing portions formed in the main portion and has four outer corner portions corresponding to two front corner portions of the main portion and two rear corner portions of the wing portions, and wherein the first relief surfaces are formed in the front and rear sides of the pillar along the four outer corner portions of the pillar.
